(19) United States
(12) Patent Application Publication
(10) Pub. No.: US 2025/0259183 A1
(43) Pub. Date: Aug. 14, 2025

(54) SYSTEMS AND METHODS FOR STREAMLINING TRANSACTION WORKFLOW UTILIZING BLOCKCHAIN OR CENTRALIZED ROUTING WITH DIRECT COMMUNICATION BETWEEN NETWORK PARTICIPANTS

(71) Applicant: TraDove, Inc., Palo Alto, CA (US)

(72) Inventor: Jun Yan, Palo Alto, CA (US)

(21) Appl. No.: 18/922,137

(22) Filed: Oct. 21, 2024

Related U.S. Application Data
(63) Continuation-in-part of application No. 18/597,872, filed on Mar. 6, 2024, now abandoned.
(60) Provisional application No. 63/657,790, filed on Jun. 8, 2024.
(60) Provisional application No. 63/638,116, filed on Apr. 24, 2024.
(60) Provisional application No. 63/636,688, filed on Apr. 19, 2024.
(60) Provisional application No. 63/560,400, filed on Mar. 1, 2024.
(60) Provisional application No. 63/606,054, filed on Dec. 4, 2023.
(60) Provisional application No. 63/589,877, filed on Oct. 12, 2023.
(60) Provisional application No. 63/587,062, filed on Sep. 29, 2023.
(60) Provisional application No. 63/579,457, filed on Aug. 29, 2023.
(60) Provisional application No. 63/517,602, filed on Aug. 3, 2023.
(60) Provisional application No. 63/511,133, filed on Jun. 29, 2023.
(60) Provisional application No. 63/510,420, filed on Jun. 27, 2023.
(60) Provisional application No. 63/501,128, filed on May 9, 2023.
(60) Provisional application No. 63/499,080, filed on Apr. 28, 2023.
(60) Provisional application No. 63/489,412, filed on Mar. 9, 2023.
(60) Provisional application No. 63/488,731, filed on Mar. 6, 2023.
(60) Provisional application No. 63/488,729, filed on Mar. 6, 2023.
(60) Provisional application No. 63/638,105, filed on Apr. 24, 2024.

(51) Int. Cl. G06Q 20/40; G06Q 20/22; G06Q 20/32; G06Q 20/38

(52) U.S. Cl. CPC G06Q 20/407; G06Q 20/223; G06Q 20/3276; G06Q 20/389

(57) ABSTRACT

A system includes computing nodes coupled and communicating within a peer-to-peer network in a point-to-point manner. The computing nodes are part of a distributed routing network or a centralized routing platform. The computing nodes receive, via a communications subsystem, from one or more upstream entities, a record of a transaction between the one or more upstream entities, recording, within the distributed routing network or the centralized routing platform, a log entry, route, in a point-to-point manner, the log entry to one or more downstream entities, receive, from the one or more downstream entities, an authorization of the transaction, route, to the one or more upstream entities, the authorization of the transaction, and updating the record of the transaction at the distributed routing network or a centralized routing platform by appending the authorization of the transaction and to provide a guarantee of validity of the transaction.

### CROSS-REFERENCE TO RELATED APPLICATIONS

This application claims the benefit under 35 U.S.C. § 119 (e) of U.S. Provisional Application Ser. No. 63/657,790, filed Jun. 8, 2024, U.S. Provisional Application Ser. No. 63/638,116, filed Apr. 24, 2024, U.S. Provisional Application Ser. No. 63/636,688, filed Apr. 19, 2024, and is a continuation in part (CIP) that claims the benefit under 35 U.S.C. § 120 of U.S. application Ser. No. 18/597,872, filed Mar. 6, 2024, which claims the benefit under 35 U.S.C. § 119 (e) of U.S. Provisional Application Ser. No. 63/560,400 filed Mar. 1, 2024, U.S. Provisional Application Ser. No. 63/606,054 filed Dec. 4, 2023, U.S. Provisional Application Ser. No. 63/589,877 filed Oct. 12, 2023, U.S. Provisional Application Ser. No. 63/587,062 filed Sep. 29, 2023, U.S. Provisional Application Ser. No. 63/579,457 filed Aug. 29, 2023, U.S. Provisional Application Ser. No. 63/517,602 filed Aug. 3, 2023, U.S. Provisional Application Ser. No. 63/511,133 filed Jun. 29, 2023, U.S. Provisional Application Ser. No. 63/510,420 filed Jun. 27, 2023, U.S. Provisional Application Ser. No. 63/501,128 filed May 9, 2023, U.S. Provisional Application Ser. No. 63/499,080 filed Apr. 28, 2023, U.S. Provisional Application Ser. No. 63/489,412 filed Mar. 9, 2023, U.S. Provisional Application Ser. No. 63/488,731 filed Mar. 6, 2023, and United States Provisional Application Ser. No. 63/488,729 filed Mar. 6, 2023, the contents of which are incorporated by reference in its entirety into the present disclosure.

### TECHNICAL FIELD

This disclosure relates to blockchain or centralized routing environments, and more specifically some embodiments disclosed herein relate to systems and methods for providing novel transaction or payment (e.g., credit card, debit card, check card, gift card, credit line, or other alternative payment) solutions utilizing blockchain technologies, together with quick-response (QR) code and point-of-sale (PoS) mechanisms. These solutions may be integrated with government or other money transfer services such as ACH, RTP, FedNow®. These solutions are technological improvements over conventional systems and methods.

### BACKGROUND

Currently, payment processes, whether card-based or non-card-based transactions, are highly sophisticated, costly, time-consuming, and complicated, and require extensive coordination among many entities in order to be successful. For example, a common payment card based transaction may involve coordination between the cardholder, the merchant, the acquiring bank (i.e., the merchant's bank), the issuing bank (i.e., the bank that issued the card to the cardholder), the acquiring processor (i.e., the entity providing a service, software, or device that allows merchants to accept cards for payment, e.g., the PoS device), and the card network (i.e., one or more entities operating the network that processes card based payments and govern interchange fees).

Because, in the traditional framework, the card network provider (e.g., Visa®, Mastercard®, American Express®, etc.) exercises ultimate control over the conventional payment card-based transaction process, the card network imposes fees for facilitating such processing. Within the traditional framework, various fees are imposed by entities that are in a position to control one or more steps in the processes carried out in a payment card-based transaction (e.g., authentication, authorization, clearing, settlement, management of accounts, etc.). For example, issuing banks may impose interchange fees, acquiring banks or their processors may impose processing fees, and card networks may impose added processing fees for coordinating steps between the acquiring banks and issuing banks involved. Problems with the traditional framework include high fees for merchants, inefficiencies and delays in processing and settlement time resulting from involvement of the multitude of entities, network congestion, and possibilities of security breaches. The traditional framework has caused pushback, as evidenced by the Credit Card Competition Act in the United States, which aims to lower fees in credit card transactions. However, the Credit Card Competition Act has triggered additional concerns among cardholders that the lower fees will reduce or eliminate rewards or cash back incentives. In addition, concerns of delays and possible security breaches remain unresolved.

### SUMMARY

Many of the steps in the traditional framework, and much of the computational burden to perform such steps, may be replaced by implementing the ecosystems, architectures, frameworks, systems and methods provided in the present disclosure. By implementing the technology of the present disclosure, fees associated with the old and overly complex framework may be reduced or entirely eliminated (e.g., in the case of the card network fees, card network related fees, merchant processing fees, and acquiring fees). As described herein, these elegant frameworks providing more efficient computation, storage, and processing, with enhanced privacy and/or security along with additional benefits to all related stakeholders. These frameworks are also less expensive and more versatile, thereby providing a viable solution that cuts out unnecessary processing intermediaries (e.g., Visa®, Mastercard®, Discover®, American Express® and related processors and acquirers). The technologies presented herein provide improvements in computing technology, such as improved and immutable recording of transactions, via blockchain ledgers stored at different entities, blockchain or centralized (e.g., non-blockchain) routing of payment information, more efficient data storage, and improvements in computational efficiency as a result of removing or reducing intermediate processors.

The solutions of the present disclosure provide a fundamentally different and monumental alternative to the traditional process. With the technology of the present disclosure, transactions can be completed (authorized, authenticated, validated, cleared, and settled) without contacting or coordinating with a card network for most or all transactions. With the solutions of the present disclosure, the transaction process may be more efficient (eliminating several steps and intermediate entities or processors and acquirers in the conventional process) for transactions meeting certain criteria, and various fees associated with the conventional card payment transaction processes may be mitigated or eliminated. Moreover, the flexibility that the technology of the present disclosure provides to participants is virtually limitless. Embodiments of the disclosure will be discussed in further detail herein.

A claimed solution rooted in computer technology overcomes problems specifically arising in the realm of computer technology—namely an excessively onerous and overly redundant validation, clearance and settlement processes upon which payment transactions remain contingent.

In embodiment of the systems, methods, and frameworks disclosed herein, the technology of the present disclosure may include hardware (e.g., one or more processors; and one or more memory devices storing instructions which, when executed by the one or more processors, cause the system to perform operations disclosed herein), software, and/or firmware, and/or one or more components and/or one or more steps.

In some embodiments, the validation indication results from a one or more of a consensus operation. In some embodiments, the validation indication results from one or more of non-blockchain (e.g., centralized) routing, a proof-of-authority consensus operation, a proof-of-history consensus operation, and a proof-of-work consensus operation, a proof-of-two consensus operation and a proof-of-stake consensus operation, etc.

In some embodiments, a system comprises a plurality of computing nodes, the plurality of computing nodes coupled and communicating within a peer-to-peer network in a point-to-point manner, wherein a computing node of the plurality of computing nodes comprises one or more processors; memory coupled to the one or more processors, and storing instructions for execution by at least some of the one or more processors; and a distributed routing network or a centralized routing platform associated with the computing node. The one or more processors operate to configure the computing node to perform operations. The operations include receiving, via a communications subsystem, from one or more upstream entities, a record of a transaction between the one or more upstream entities or between transacting entities associated with the one or more upstream entities; recording, within the distributed routing network or the centralized routing platform associated with the computing node, a log entry comprising the transaction; routing, in a point-to-point manner, the log entry of the transaction to the one or more downstream entities; receiving, from the one or more downstream entities, an authorization of the transaction; routing, to the one or more upstream entities, the authorization of the transaction; and updating the record of the transaction at the distributed routing network or a centralized routing platform by appending the authorization of the transaction and to provide a guarantee of validity of the transaction.

In some embodiments, the one or more processors operate to configure the computing node to perform: in response to receiving the authorization, initiating a fiat settlement from a payer bank account to a merchant bank account via back end settlement channels.

In some embodiments, the peer-to-peer network and the plurality of computing nodes are configured to process transactions belonging to a particular category of transacting entities, the particular category being defined based on a size, a type, or a region of the transacting entities; or the peer-to-peer network is dedicated to a particular transacting entity, the peer-to-peer network and the plurality of computing nodes being configured to process transactions belonging to the particular transacting entity.

In some embodiments, the record of the transaction comprises an indicia that specifies a transacting category of a particular transacting entity involved in the transaction; and the one or more processors operate to configure the computing node to perform: verifying that the transacting category matches the particular category; and the receiving of the record of the transaction is in response to verifying that the transacting category matches the particular category.

In some embodiments, the plurality of computing nodes comprise first computing nodes and the peer-to-peer network comprises a first peer-to-peer network; and the system further comprises second computing nodes coupled to and communicating within a second peer-to-peer network, the first peer-to-peer network being dedicated to a first category of transacting entities and the second peer-to-peer network being dedicated to a second category of transacting entities, the first category and the second category being distinguished based on a size, a type, or a region of the transacting entities.

In some embodiments, each of the computing nodes are hosted by a different party selected from parties, the parties comprising a card network, an issuer, a bank, a credit union, and a merchant.

In some embodiments, the plurality of computing nodes are hosted by a virtual computing machine on a physical server, the virtual computing machine comprising: one or more simulated central processing units (CPUs) or simulated graphical processing units (GPUs) accessible by the plurality of computing nodes; and a hypervisor that maps the simulated CPUs or simulated GPUs onto the physical server.

In some embodiments, the plurality of computing nodes comprise first computing nodes; the virtual computing machine comprises a first virtual computing machine; and the system further comprises second computing nodes hosted by a second virtual computing machine on the physical server.

In some embodiments, the computing node is configured to transmit and receive communications directly to and from the one or more upstream entities and the one or more downstream entities in a point-to-point manner, the transacting entities comprise a payer and a merchant, the one or more upstream entities being associated with a device, a digital application, or a digital wallet of the merchant or the payer, the transaction comprises a credit or a debit transaction using a transaction instrument; and the one or more downstream entities are associated with a digital banking core or an issuer or processing system of the transaction instrument.

In some embodiments, a system comprises a plurality of computing nodes, the plurality of computing nodes coupled and communicating within a peer-to-peer network in a point-to-point manner, wherein a computing node of the plurality of computing nodes comprises: one or more processors; memory coupled to the one or more processors, and storing instructions for execution by at least some of the one or more processors; a distributed routing network or a centralized routing platform associated with the computing node; and wherein the one or more processors operate to configure the computing node to perform operations. The operations include: receiving, via a communications subsystem, from one or more upstream entities, a record of a transaction between the upstream entities or between transacting entities associated with the one or more upstream entities, the record indicating transaction data; generating a token specific to the upstream entities or the transacting entities, the token encoding the transaction data; transmitting, in a point-to-point manner, the generated token to an upstream entity of the upstream entities or a transacting entity of the transacting entities; receiving a stamped token from the upstream entity or from the transacting entity, the stamped token representing an approval of the recorded transaction; routing, in a point-to-point manner, the stamped token to one or more downstream entities; receiving an indication of an authorization of the transaction from the one or more downstream entities; routing, to the upstream entities or the transacting entities, a record of the authorized transaction; and recording an entry of the authorized transaction at the distributed routing network or a centralized routing platform.

In some embodiments, the transaction data comprises identification data of a credit account or a debit account and an amount of the transaction.

In some embodiments, the one or more upstream entities comprise devices or digital applications associated with a payer or a payee, the transacting entities comprise the payer and the payee, and the receiving of the record of the transaction is in response to a scanning on the digital application of a quick response (QR) code or in response to a communication between the devices associated with the payer and the payee of an inputted and approved transaction amount using a near field communications (NFC) protocol.

In some embodiments, the receiving of the record of the transaction is in response to a selection, on a digital application of the payer, of a credit or debit account and an approval of the transaction and transaction amount, wherein the credit or debit account is selected from any of a credit score based credit account, a term loan, a SBA loan, an uncollateralized credit line, a collateralized credit line, a checking or savings account, or a traditional credit account, and the approval of the transaction is performed using biometrics or a pass code entry.

In some embodiments, the one or more downstream entities is associated with a payer bank of the payer; the receiving of the indication of the authorization comprises receiving an adjustment from the selected credit or debit account of the transaction amount and the recording of the entry of the authorized transaction comprises recording the adjustment of the selected credit or debit account.

In some embodiments, the stamped token represents a computing command from the upstream entity that approves a payer bank of a payer to transmit a transaction amount to a payee bank of a payee in near real-time or by batching one or more transactions.

In some embodiments, the receiving of the indication of the authorization comprises a confirmation of a sufficient balance on a transaction account for settlement of the transaction and a settlement of the transaction using the transaction account.

In some embodiments, the settlement of the transaction comprises a closed loop settlement in which the transaction account belonging to a payer is debited and a payee account is credited, wherein the transaction account and the payee account belong to a common financial institution.

In some embodiments, the transaction comprises a fiat transfer; and the one or more upstream entities comprise a point-of-sale (PoS) device, and the receiving of the indication of the authorization of the transaction from the one or more downstream entities corresponds to an indication of a fiat settlement from the transaction account belonging to a payer to a payee account.

In some embodiments, the one or more downstream entities is associated with a payer bank; and the receiving of the indication of the authorization of the transaction corresponds to posting a charge of the transaction against an account of the payer bank, wherein the transaction includes any discounts, rewards, and fees.

In some embodiments, the transaction comprises a refund transaction of a previous transaction; and the receiving of the record of the transaction comprises receiving an indication of the previous transaction to be refunded; or wherein the transaction comprises a reversal of a previously unsettled transaction; and the receiving of the indication of the authorization of the transaction corresponds to a credit to an account of a payer corresponding to a previously locked amount corresponding to the previously unsettled transaction; or wherein the transaction comprises a chargeback of a previous transaction; and the receiving of the indication of the authorization of the transaction is from a payer bank of a payer or an external entity besides the payer bank; the receiving of the indication of the authorization corresponds to a credit to an account of a payer corresponding to a previous transaction amount of the previous transaction.

In some embodiments, the transaction comprises a preauthorization and a final settlement according to a smart contract; and the receiving of the indication of the authorization corresponds to a locking of an amount corresponding to the preauthorization and a settlement amount of the final settlement, wherein the smart contract is recorded within the distributed ledger or the storage system.

In some embodiments, the one or more processors operate to configure the computing node to perform: receiving an indication of one or more processing fees associated with a transacting entity of the transacting entities; and recording an entry of the processing fees at the distributed ledger or the storage system.

In some embodiments, the one or more processors operate to configure the computing node to perform: receiving an indication of a rating provided to a transacting entity; and recording an entry of the rating provided to the transacting entity, wherein the rating is displayed in response to a request or upon scanning of a QR code associated with the transacting entity or inputting of an alphanumeric code associated with the transacting entity.

In some embodiments, the one or more processors operate to configure the computing node to perform: generating a record or log of transactions or accounting records; and transmitting the generated record or log to the one or more upstream entities or the one or more downstream entities periodically or in near real-time.

In some embodiments, a computing system comprises: a server configured to store wallet data from a plurality of wallets, wherein the wallets are linked to same or different accounts of a transacting entity and the wallet data comprises account data of one or more particular accounts associated with the wallets; one or more processors; and a memory storing instructions that, when executed by the one or more processors, causes the one or more processors to perform operations. The operations include: generating one or more QR codes or scannable codes encoding the wallet data and associated with the wallets; receiving a scan of a particular QR code or a particular scannable code or an input of a particular alphanumeric code, or scanning an external QR code or an external scannable code; receiving an input of transaction data; receiving a confirmation of a transaction according to the transaction data; in response to receiving the scan, the input, and the confirmation, automatically transmitting the transaction data to a downstream entity, the downstream entity comprising a distributed routing network or a centralized routing platform; receiving an authorization of the transaction from the downstream entity; and in response to receiving the authorization, updating the wallet data based on the transaction data.

In some embodiments, the transaction data comprises a sales tax, a tip, a discount, reward, or fee associated with the transaction.

In some embodiments, the particular QR code or the particular scannable code encodes or encrypts any or a transaction amount, and merchant bank data, the merchant bank data comprising any of an account identifier, a routing identifier, and a payment method identifier or a payment method.

In some embodiments, a computing system comprises: a server configured to store account data from a plurality of accounts; one or more processors; and a memory storing instructions that, when executed by the one or more processors, causes the one or more processors to perform operations. The operations include generating one or more QR codes, scannable codes, or alphanumeric codes encoding the account data, wherein each of the generated QR codes, the generated scannable codes, and the alphanumeric codes are associated with one or more of the accounts; receiving a scan of a particular QR code or a particular scannable code or an input of a particular alphanumeric code, or scanning an external QR code or an external scannable code; receiving an input of transaction data, the transaction data comprising a transaction amount and a transacting entity; receiving, via biometrics, two-factor authentication, or a passcode, a confirmation of a transaction corresponding to the transaction data; selecting a particular account based on a criteria, the criteria comprising one or more incentives associated with the accounts; transmitting, to the transacting entity, a confirmation of the transaction and the selected particular account; receiving, from a downstream entity, an approval of the transaction; and generating a record of the transaction.

In some embodiments, the downstream entity is associated with a banking application; and the approval of the transaction corresponds to a debit of the selected particular account according to the transaction amount.

In some embodiments, the criteria is based on a geolocation, a type of the transaction, an industry of the transacting entity, or the account data.

In some embodiments, a computing system comprises a plurality of computing nodes, the plurality of computing nodes coupled and communicating within a peer-to-peer network in a point-to-point manner, wherein a computing node of the plurality of computing nodes comprises: one or more processors; memory coupled to the one or more processors, and storing instructions for execution by at least some of the one or more processors; a distributed routing network or a centralized routing platform associated with the computing node; and wherein the one or more processors operate to configure the computing node to perform operations. The operations include storing, within the distributed routing network or the centralized routing platform, available redemptions corresponding to the first transacting entity; receiving, via a communications subsystem, from one or more upstream entities or from transacting entities, a record of a transaction between the transacting entities, the transacting entities comprising a first transacting entity and a second transacting entity; recording, within the distributed routing network or the centralized routing platform associated with the computing node, a first log entry comprising the transaction; converting, within the distributed routing network or the centralized routing platform, the transaction to an equivalent redemption being accumulated by the first transacting entity; updating, within the distributed routing network or the centralized routing platform, the available redemptions based on the equivalent redemption; transmitting, to the first transacting entity and the second transacting entity, an indication of the available redemptions being accumulated by the first transacting entity; receiving, from the first transacting entity, a redemption request to redeem at least a portion of the available redemptions; verifying, from the distributed routing network or the centralized routing platform, a sufficiency of the available redemptions to satisfy the redemption request or an eligibility of the redemption request; transmitting the redemption request to the second transacting entity or a third transacting entity associated with the redemption request; receiving, from the first transacting entity, the second transacting entity, or the third transacting entity, a verification of a fulfillment of the redemption request; recording, within the distributed routing network or the centralized routing platform, a second log entry comprising the verification of the fulfillment of the redemption request; and updating, within the distributed routing network or the centralized routing platform, the updated available redemptions based on the verification of the fulfillment of the redemption request.

In some embodiments, the one or more processors further operate to configure the computing node to perform: transmitting, to one or more digital applications or a financial institution, an indication of the equivalent redemption, the updated available redemptions based on the equivalent redemption, or the updated available redemptions based on the verification of the fulfillment of the redemption request, wherein the one or more digital applications or the financial institution are associated with the first transacting entity, the second transacting entity, the third transacting entity, or an external entity.

In some embodiments, the redemption request comprises a request by the first transacting entity to redeem the at least the portion of the updated available redemptions with the third transacting entity.

In some embodiments, the one or more processors further operate to configure the computing node to perform: receiving, from the second transacting entity and the third transacting entity, within the distributed routing network or the centralized routing platform, redemption policies provided by the second transacting entity and the third transacting entity, wherein the redemption policies are based on a type of the first transacting entity or a transaction history of the first transacting entity; and storing, within the distributed routing network or the centralized routing platform, the redemption policies.

In some embodiments, the one or more processors further operate to configure the computing node to perform transmitting, from the distributed routing network or the centralized routing platform, the redemption policies to one or more digital applications associated with a financial institution related to the first transacting entity or to one or more digital applications associated with a financial institution related to an external entity.

In some embodiments, the one or more processors further operate to configure the computing node to perform: tracking a transaction history of the first transacting entity; based on the transaction history of the first transacting entity, generating, based on one or more machine learning components, one or more customized redemption options and one or more redemption validity periods during which the customized redemption options are valid; and storing, within the distributed routing network or the centralized routing platform, the one or more customized redemption options.

In some embodiments, the generating of the one or more customized redemption options is based on a historical frequency of a type of transactions performed by the first transacting entity; and the one or more customized redemption options correspond to the type of transactions.

In some embodiments, the receiving of the redemption request from the first transacting entity is at a terminal associated with the second transacting entity.

In some embodiments, the verifying of the sufficiency or the eligibility of the redemption request comprises receiving an authorizing of the redemption request from the second transacting entity, an external entity, or a financial institution associated with the first transacting entity or the second transacting entity; and the one or more processors further operate to configure the computing node to perform: receiving a confirmation of the redemption request from the second transaction entity.

In some embodiments, the one or more processors further operate to configure the computing node to perform: receiving, from the second transacting entity, one or more redemption options, one or more eligible entity types or eligible entities, and one or more one or more redemption validity periods during which the one or more redemption options are valid; storing, within the distributed routing network or the centralized routing platform, the one or more redemption options, the one or more redemption validity periods, and the one or more eligible entity types or eligible entities; and transmitting the one or more redemption options to a downstream destination, wherein the downstream destination comprises a different computing system, a digital wallet or a digital application associated with a financial institution related to the first transacting entity or the second transacting entity, or to an external entity.

In some embodiments, the receiving of the redemption request from the first transacting entity comprises: receiving a scan or an input of a transaction instrument associated with the distributed routing network or the centralized routing platform; providing, to the first transacting entity, the one or more redemption options; receiving, from a digital wallet or application associated with the first transacting entity, a selection of a particular redemption option; and wherein: the transaction comprises a first transaction; the particular redemption option is associated with a second transaction; and the recording, within the distributed routing network or the centralized routing platform, of the second log entry comprises recording an adjusted second transaction based on the fulfillment of the redemption request.

In some embodiments, the receiving of the redemption request from the first transacting entity comprises: receiving a scan or an input of a transaction instrument by the first transacting entity; providing, to the first transacting entity, the one or more redemption options; receiving, from a digital wallet or application associated with the first transacting entity, a selection of a particular redemption option; generating a QR code associated with the selected particular redemption option; receiving, from the second transacting entity, or from a digital application or a digital wallet associated with the second transacting entity, a scan of the generated QR code; in response to receiving the scan, receiving, from the second transacting entity, or from the digital application or the digital wallet associated with the second transacting entity, a confirmation of the selected particular redemption option, wherein the transaction comprises a first transaction and the selected particular redemption option is associated with a second transaction; generating a token, at the distributed routing network or the centralized routing platform, that represents the selected particular redemption option; transmitting, at the distributed routing network or the centralized routing platform, the generated token to a downstream destination, wherein the downstream destination comprises a different computing system, a digital wallet or a digital application associated with a financial institution related to the first transacting entity or the second transacting entity, or to an external entity.

In some embodiments, a computing system comprising: a plurality of computing nodes, the plurality of computing nodes coupled and communicating within a peer-to-peer network in a point-to-point manner, wherein a computing node of the plurality of computing nodes comprises: one or more processors; memory coupled to the one or more processors, and storing instructions for execution by at least some of the one or more processors; a distributed routing network or a centralized routing platform associated with the computing node; and wherein the one or more processors operate to configure the computing node to perform operations. The operations include storing, at the distributed routing network or the centralized routing platform, preloaded account data associated with one or more preloaded open accounts, wherein the preloaded account data comprises one or more attributes associated with the preloaded open accounts; receiving, at the distributed routing network or the centralized routing platform, a request to initiate a new preloaded open account or a modification to an existing preloaded open account, wherein the request is triggered by a generating of a code or a scanning of the code by a digital application associated with a first transacting entity or with a second transacting entity, wherein the first transacting entity comprises a requestor of the new or existing preloaded open account and the second transacting entity comprises an issuer of the new or existing preloaded open account, and the code encodes new or existing preloaded account data; validating, at the distributed routing network or the centralized routing platform, the request to modify the attribute; and in response to validating the request, triggering a fulfillment of the request and updating the preloaded account data at the distributed routing network or the centralized routing platform in accordance with the request.

In some embodiments, the attributes comprises preloaded assets associated with the preloaded open accounts; the validating of the request comprises: transmitting, to the downstream entity, a validation request to validate one or more account attributes of an account associated with the downstream entity and associated with the first transacting entity and receiving, from the downstream entity, an indication of whether the account attributes satisfy the request.

In some embodiments, the preloaded open account corresponds to a digital wallet associated with the first transacting entity; and the triggering of the fulfillment comprises: transmitting, to the downstream entity, a fulfillment request; receiving, at the distributed routing network or the centralized routing platform, a fulfillment indication that the fulfillment request has been satisfied; and transmitting the fulfillment indication to the digital wallet to update the digital wallet.

In some embodiments, the downstream entity comprises a first downstream entity; and the fulfillment request comprises a transfer of assets from the first downstream entity to a second downstream entity, the second downstream entity being associated with an account or a digital wallet belong to the second transacting entity.

In some embodiments, the digital wallet associated with the first transacting entity comprises a first digital wallet; and the one or more processors further operate to configure the computing node to perform: storing, at the distributed routing network or the centralized routing platform, second wallet data corresponding to a second digital wallet associated with the first transacting entity, wherein the second wallet data comprises second wallet attributes of the second digital wallet, the second wallet attributes comprising second wallet assets; receiving a transfer request, from the first transacting entity, at the distributed routing network or the centralized routing platform, to transfer at least a portion of the preloaded assets into the second digital wallet; validating, at the distributed routing network or the centralized routing platform, a sufficiency of the preloaded assets to fulfill the transfer request; receiving, at the distributed routing network or the centralized routing platform, an indication that the transfer request has been fulfilled; recording, at the distributed routing network or the centralized routing platform, a log entry indicating that the transfer request has been fulfilled; and updating, at the distributed routing network or the centralized routing platform, the second wallet data and the preloaded account data in response to the fulfillment of the transfer request.

In some embodiments, the one or more processors further operate to configure the computing node to perform: storing, at the distributed routing network or the centralized routing platform, wallet data.

In some embodiments, a computing system comprising: a plurality of computing nodes, the plurality of computing nodes coupled and communicating within a peer-to-peer network in a point-to-point manner, wherein a computing node of the plurality of computing nodes comprises: one or more processors; memory coupled to the one or more processors, and storing instructions for execution by at least some of the one or more processors; a distributed routing network or a centralized routing platform associated with the computing node; and wherein the one or more processors operate to configure the computing node to perform: receiving, via a communications subsystem, a record of a transaction between a first transacting entity and a second transacting entity, the record indicating transaction data, wherein the receiving of the record of the transaction is in response to a scanning, by the first transacting entity or the second transacting entity, of a QR code or a scannable code associated with a preloaded open account of the first transacting entity or associated with the second transacting entity; generating a token specific to the first transacting entity and a second transacting entity, the token encoding the transaction data; transmitting the token to a downstream entity, transmitting, in a point-to-point manner, the generated token to an upstream entity of the upstream entities or a transacting entity of the transacting entities; receiving a stamped token from the upstream entity or from the transacting entity, the stamped token representing an approval of the recorded transaction; routing, in a point-to-point manner, the stamped token to one or more downstream entities; receiving an indication of an authorization of the transaction from the one or more downstream entities; routing, to the upstream entities or the transacting entities, a record of the authorized transaction; and recording an entry of the authorized transaction at the distributed routing network or a centralized routing platform.

### BRIEF DESCRIPTION OF THE DRAWINGS

FIG. 1A is a diagram illustrating a schematic representation of a non-blockchain ecosystem.

FIG. 1B is a diagram illustrating a consolidated ecosystem or a blockchain ecosystem that includes blockchain nodes.

FIG. 1C is a diagram illustrating a consolidated ecosystem or a blockchain ecosystem that includes blockchain nodes.

FIG. 2 is a diagram illustrating an example configuration of a distributed ledger with which embodiments of the systems and methods disclosed herein may be implemented.

FIG. 3A is a diagram illustrating a transaction process among network participants and entities coordinated by one or more blockchain nodes, in accordance with some embodiments.

FIG. 3B is a diagram illustrating a rewards process among network participants and entities coordinated by one or more blockchain nodes, in accordance with some embodiments.

FIG. 4A is a schematic illustration of a refund or reversal process, in accordance with some embodiments, consistent with the previous description in FIGS. 1B-1C, in accordance with some embodiments.

FIG. 4B is a schematic illustration that depicts a preauthorization process 450 among network participants and entities coordinated by the one or more blockchain nodes 160, consistent with the previous description in FIGS. 1B-1C, in accordance with some embodiments.

FIG. 5 is a schematic illustration that depicts a chargeback process among network participants and entities coordinated by the one or more blockchain nodes 160, consistent with the previous description in FIGS. 1B-1C, in accordance with some embodiments.

FIGS. 6-8 are schematic illustrations that depict a settlement process among network participants and entities coordinated by the one or more blockchain nodes 160, consistent with the previous description in FIGS. 1B-1C, in accordance with some embodiments.

The figures are not exhaustive and do not limit the present disclosure to the precise form disclosed.

### DETAILED DESCRIPTION

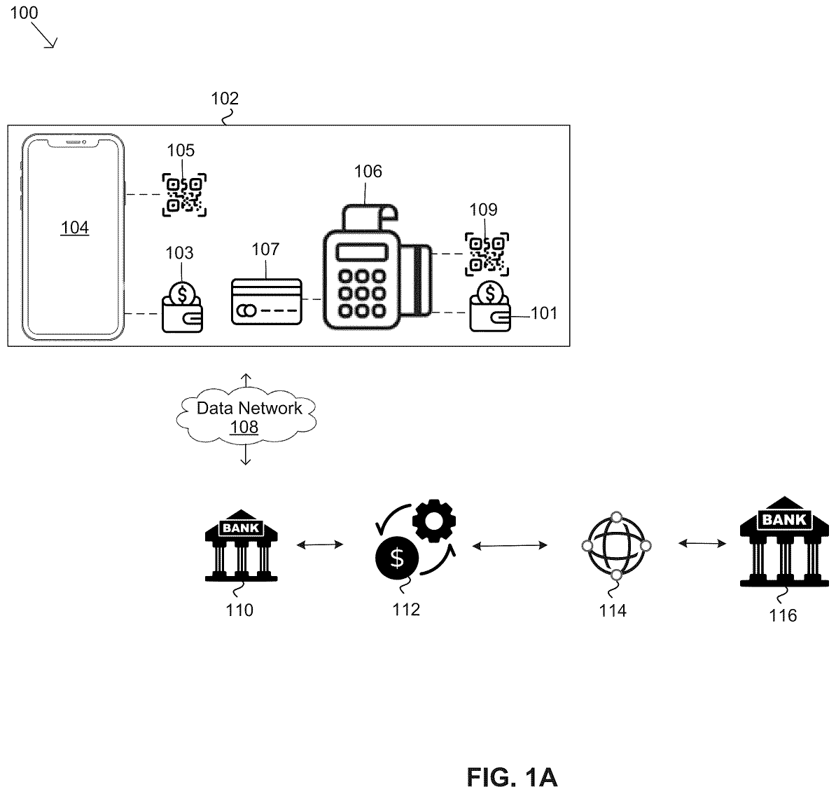

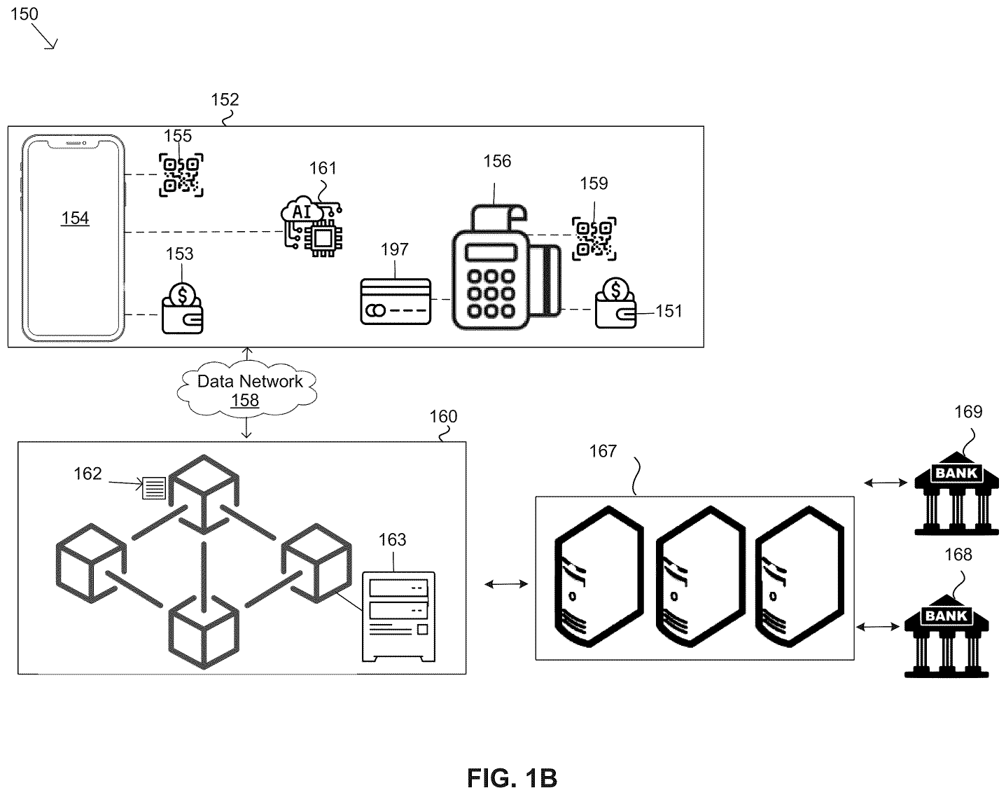

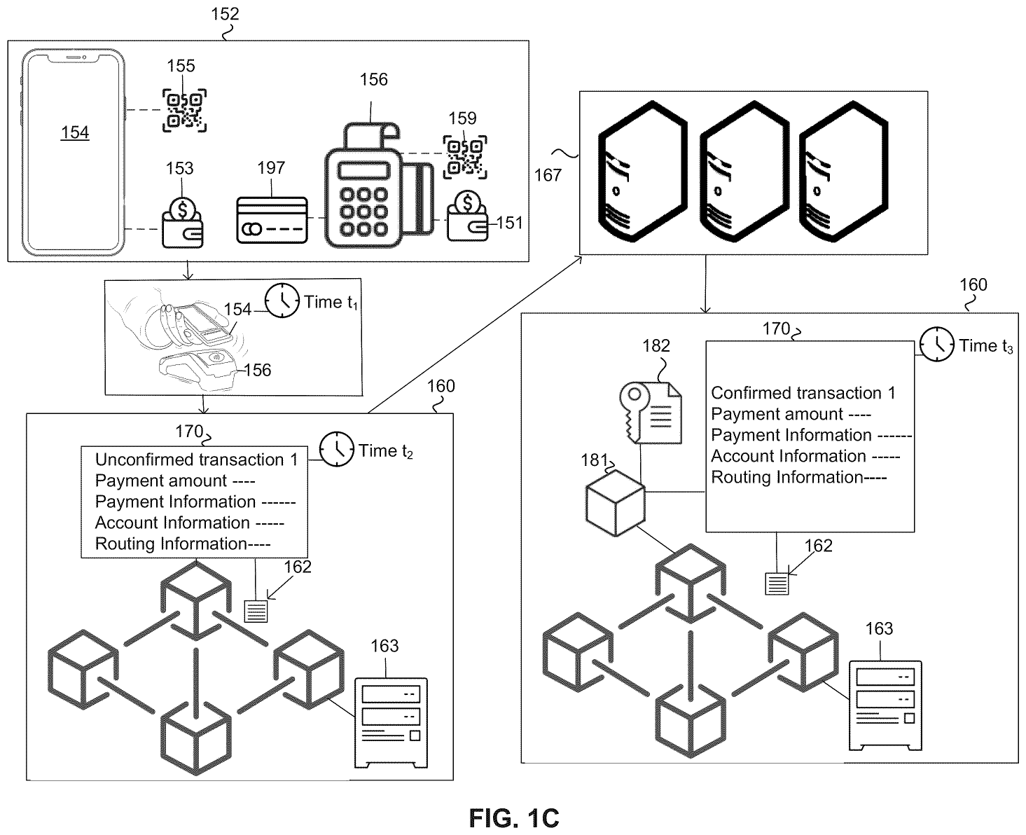

Transaction instruments, such as digital applications, digital wallets, and/or payment cards connected with the digital applications and/or the digital wallets, may be implemented within different ecosystems or rails (hereinafter “ecosystems”). The different ecosystems may include, without limitation, a non-blockchain ecosystem, as illustrated in FIG. 1A, and a consolidated ecosystem or a blockchain ecosystem (hereinafter “consolidated ecosystem”) that includes blockchain nodes, as illustrated in FIGS. 1B and 1C. In some embodiments, a particular digital wallet and/or a particular digital application, and/or an associated payment card, may connect to and be implemented within both the non-blockchain ecosystem and/or the consolidated ecosystem. In some embodiments, certain digital wallets and/or digital applications, such as those connected to alternative credit/debit payment accounts, may be connected to and implemented within only the consolidated ecosystem.

In FIG. 1A, within a non-blockchain ecosystem 100, one or more devices 102 may be associated with one or more network participants. The one or more devices 102 may include hardware, software, and/or firmware configured to initiate, propose, and/or confirm an event, such as a transaction. For example, the one or more devices 102 may communicate and/or interface with payers and payees, and/or with other network participants. A transaction may include a purchase of goods or services, a preauthorization, a reversal, a return, a chargeback, and/or other transactions performed between network participants. The one or more devices 102 may include a mobile device 104 associated with and/or interfacing with a first network participant, such as a payer, and/or a terminal or mobile device 106 associated with and/or interfacing with a second network participant, such as a payee. The one or more devices 102 may include, without limitation, any of a computer, a handheld device such as a mobile phone, tablet, smartphone, desktop, netbook, personal digital assistant (PDA), and/or other computing devices such as a point-of-sale (PoS) terminal and/or a server. In some embodiments, the mobile device 104 may host, or be programmed with, a digital application 105 and/or a digital wallet 103. The digital application 105 and/or the digital wallet 103 may be used to initiate and/or approve a transaction via reading, scanning, and/or otherwise inputting of codes such as QR codes or alphanumeric codes. In some examples, the digital wallet 103 may be integrated or associated with a card (e.g., a debit, credit, gift, prepaid, and/or other payment card) or other payment mechanism. In some embodiments, the terminal 106 may include a PoS terminal, stand, and/or a gateway, and may implement readers, near field communication (NFC) and/or radio-frequency identification (RFID) technologies. In some embodiments, the terminal 106 may host, or be programmed with, a digital application 109 and/or a digital wallet 101. The digital application 109 and/or the digital wallet 101 may be used to initiate and/or approve a transaction via reading, scanning, and/or otherwise inputting of codes such as QR codes or alphanumeric codes at the terminal 106. In some embodiments, the terminal 106, such as a PoS device, may contain one or more APIs to enable electronic check out.

As alluded to, a transaction may either be initiated by scanning or inputting a code through the digital application 109 of the terminal 106 or through the digital application 105 of the mobile device 104. If initiated through the digital application 109, the terminal 106 receives an indication of a payment or attempted payment, via a specified payment method and/or payment schedule encoded by the scanned or inputted code (e.g., a QR code or alphanumeric code). In some embodiments, this code may have been generated by the digital application 105. In other embodiments, the terminal 106 may scan or read a payment mechanism, such as a card 107, with or without a digital application or a digital wallet. Thus, within the non-blockchain ecosystem 100, the terminal 106 may receive an indication of an initiated transaction and/or transaction information (e.g., payment amount, payment schedule and/or payment timing) by using NFC technologies such as NFC tapping in order to read transaction information. In the event that a transaction is initiated through the digital application 105 of the mobile device 104, the mobile device 104, via the digital application 105, may scan or input a code from the terminal 106, from the digital application 109, or from another device connected with a payee.

In FIG. 1A, within the non-blockchain ecosystem 100, the terminal 106, and/or alternatively the mobile device 104, may initiate communication with other participants via a data network and/or platform 108 in order to process, authenticate, and/or settle the transaction. The data network and/or platform 108 may include, for example, a cluster of computing components (e.g., servers). The data network and/or platform 108 may represent one or more types of computer networks (e.g., a local area network (LAN), a wide area network (WAN), etc.) and/or underlying transmission media. The data network and/or platform 108 may include a set of one or more public and/or private, wired and/or wireless networks. The data network and/or platform 108 may provide communication between the systems, engines, datastores, components, and/or devices described herein. In some example embodiments, the data network and/or platform 108 includes one or more computing devices, routers, cables, buses, and/or other network topologies (e.g., mesh network topologies). In some example embodiments, the data network and/or platform 108 may include one or more wired and/or wireless networks. In various example embodiments, the data network and/or platform 108 may include the Internet, one or more WANs, one or more LANs, and/or one or more other public, private, Internet Protocol (IP)-based, and/or non-IP-based networks.

The other participants may include, one or more of without limitation, a merchant bank 110, a merchant processor 112, a card network 114, and/or an issuer bank 116. The terminal 106 may receive transaction information associated with a credit card via NFC tapping. In some embodiments, the data network or platform 108 may route confirmed payment information from the one or more devices 102, the digital application 105, the terminal 106, and/or the digital application 109 directly to the issuer bank 116 for authorization and settlement. In some embodiments, tokenization of credits or debits may occur at an issuer level, meaning that the issuer bank 116 may tokenize the payment information. The tokenized payment information, manifested as a token, may be transmitted to the merchant, which stamps with a merchant's digital wallet identification and merchant name for security, accounting, future verification, and auditing. The merchant may redeem the token. The issuer bank 116 may send fiat money to the merchant bank 110. In other embodiments, tokenization may occur at the processing level.

Meanwhile, in FIG. 1B, within the blockchain rail, a consolidated ecosystem 150 within a blockchain supported transaction network processes transactions while eliminating intermediaries. Here, a merchant processor and card network may be combined together as a single entity or network. For larger or medium merchants, a merchant acquirer (e.g., merchant acquiring bank) and card issuer may also be combined into a single entity. This permits direct settlement between large and/or medium merchants and a card issuer for transactions, including chargebacks and refunds. The card issuer may handle chargebacks, card reversals, and/or refunds. For smaller merchants, the merchant acquirer and the card issuer may be separate, and the merchant acquirer may handle refunds, card reversals, chargebacks, and merchant credit risk management. For these smaller merchants, the acquirer may be used to advance money to merchant for guaranteed liquidity in case of reversals of previous payments. In some embodiments, the merchant acquirer can aggregate payments from other issuers to the same small merchant and offset reverse payments from previous transactions. The merchant acquirer can mitigate credit risk among a large pool of small merchants. Direct point-to-point routing between the merchant card issuer may be implemented instead of the more complicated pipeline routing between the merchant, the merchant processor, the card network, and the issuer.

The consolidated ecosystem 150 provides benefits of improved, more reliable storage, enhanced security, faster computing, more efficient communication and collaboration, lower fees and faster settlement with additional advantages to stakeholders or participants such as payers (e.g., consumers), payees (e.g., merchants), banks (e.g., payee and payer banks), and backend systems associated with the banks and/or payees. The consolidated ecosystem 150 implements private key encryption, distributed peer-to-peer computing, and incentivizing protocols incorporated within a robust computer network without single-person control, and eliminates intermediaries in routing, authorizing transactions, and recording. In some embodiments, at least some of the participants may require or be associated with a score (e.g., a credit rating) in order to join the consolidated ecosystem 150. Within the consolidated ecosystem 150, one or more devices 152 may be associated with one or more network participants. In some embodiments, the one or more devices 152 may be implemented as, or similar to, the one or more devices 102 of FIG. 1A. For example, the one or more devices 152 may communicate with payers and payees, with other network participants, and/or with one or more blockchain nodes 160. The one or more devices 152 may include a mobile device 154 associated with and/or interfacing with a first network participant, such as a payer, and/or a terminal 156, or other device configured to record a transaction, associated with and/or interfacing with a second network participant, such as a payee. In some embodiments, the mobile device 154 may host, or be programmed with, a digital application 155 and/or a digital wallet 153 used to initiate, accept, and/or approve a transaction (such as by scanning a payee QR code). In some embodiments, the digital wallet 153 may be desktop, laptop, pad and/or mobile-based. In some embodiments, the digital application 155 and/or the digital wallet 153 may be implemented the same way as the digital application 105 and/or the digital wallet 103. In some examples, the digital wallet 153 may be integrated or associated with a card (e.g., a debit, credit, gift, prepaid, and/or other payment card) and/or an account (e.g., credit account, checking account, savings account, credit line, equity line, Small Business Administration (SBA) loan, term loan, or other accounts). In some embodiments, the digital wallet 153 may also be integrated as part of a digital banking application. Alternatively, in other examples, the digital wallet 153 may be disconnected from any card and may be associated with other non-card payment mechanisms. Therefore, the same digital application and/or digital wallet may be linked to both traditional credit or debit card accounts and/or alternative credit or debit accounts such as non-card bank accounts including a credit account, a checking account, a savings account, a credit line, an equity line, a Small Business Administration (SBA) loan, a term loan, or other accounts. When a digital application and/or a digital wallet is linked to a traditional credit or debit card account, the digital application and/or the digital wallet may be implemented within either or both the non-blockchain ecosystem 100 and the consolidated ecosystem 150.

In some embodiments, the terminal 156 may include a PoS terminal, stand, gateway, mobile device, and/or other device, and may implement code reading or code scanning capabilities (e.g., QR code scanning capabilities) readers, near field communication (NFC) and/or radio-frequency identification (RFID). The terminal 156 may host, and/or be programmed with, a digital application 159 which may be a same or different digital application as the digital application 155, in order to initiate, accept, and/or approve transactions. Therefore, the payer and payee may utilize same or different digital applications to process transactions. Additionally, the terminal 156 may be programmed with a digital wallet 151, which may be a same or different type as the digital wallet 153. Each of the payer and payee may have multiple devices and/or accounts supported through a common application (e.g., the digital application 155 or 159).

In some embodiments, the digital application 159 within the terminal 156 generates a code, such as a QR code, that is encoded with a transaction amount and bank info, etc. In other embodiments, the digital application 155 within the mobile device 154 may generate a code corresponding to the payer that encodes payment information such as banking information and payment amount. In one scenario, the terminal 156, via the digital application 159, may read or scan the code generated by the digital application 155, to receive an indication of an impending, initiated, and/or attempted payment. In another scenario, the mobile device 154, via the digital application 155, may read or scan a code generated by the digital application 159 of the terminal 156. In either situation, the terminal 156 receives an indication of a payment, impending payment, or attempted payment, such as via a code (e.g., a QR code or an alphanumeric code) from the digital application 155, and/or a transfer of funds from the digital wallet 153.

In other embodiments, the terminal 156 may scan or read a payment mechanism, such as a card 197, which may or may not be linked with a digital application (e.g., the digital application 159). Once the terminal 156 scans the payment mechanism, the digital application 159 of the terminal 156 may generate and/or populate proper entries and/or fields for downstream processing, such as by the payer bank. In other embodiments, in the latter situation, the mobile device 154, via the digital application 155, rather than the terminal 156, may scan or read a code from the terminal 156 or from another device connected with a payee.

In some embodiments, blockchain nodes 160 (e.g., distributed blockchain nodes) may link different network participants within the consolidated ecosystem 150. For example, the blockchain nodes 160 may receive communications from and transmit communications to the different network participants via the terminal 156, the digital application 159, the digital wallet 151, the digital application 155, and/or the digital wallet 153, to a back-end system of a bank and/or an issuer, such as a banking digital core, issuer management system, or other processing system. Overall, the network participants and entities linked by the blockchain nodes 160 may include the payer associated with and/or interfacing with the mobile device 154, a payee associated with and/or interfacing with the terminal 156, an issuing or payer bank or entity 168 (e.g., bank or entity associated with a card or payment mechanism of the payer), a payee bank or entity 169 (e.g., bank or entity associated with the payee or merchant), a banking core or core banking system (hereinafter “banking core”) 167 which may perform functions such as authorization and/or settlement of transactions for either or both of the payer bank 168 and the payee bank 169, other banking systems, and/or management systems (e.g., retail management or inventory management systems). In some embodiments, digital core providers may have fee-sharing agreements with other participants in the consolidated ecosystem 150, such as the payer bank 168, and/or the payee bank 169. For example, transaction fees may be shared among one or more of digital core providers, payer banks or credit unions, payee banks or credit unions, and/or other banks or credit unions within a consortium that hosts the blockchain nodes 160, and/or other related partners.

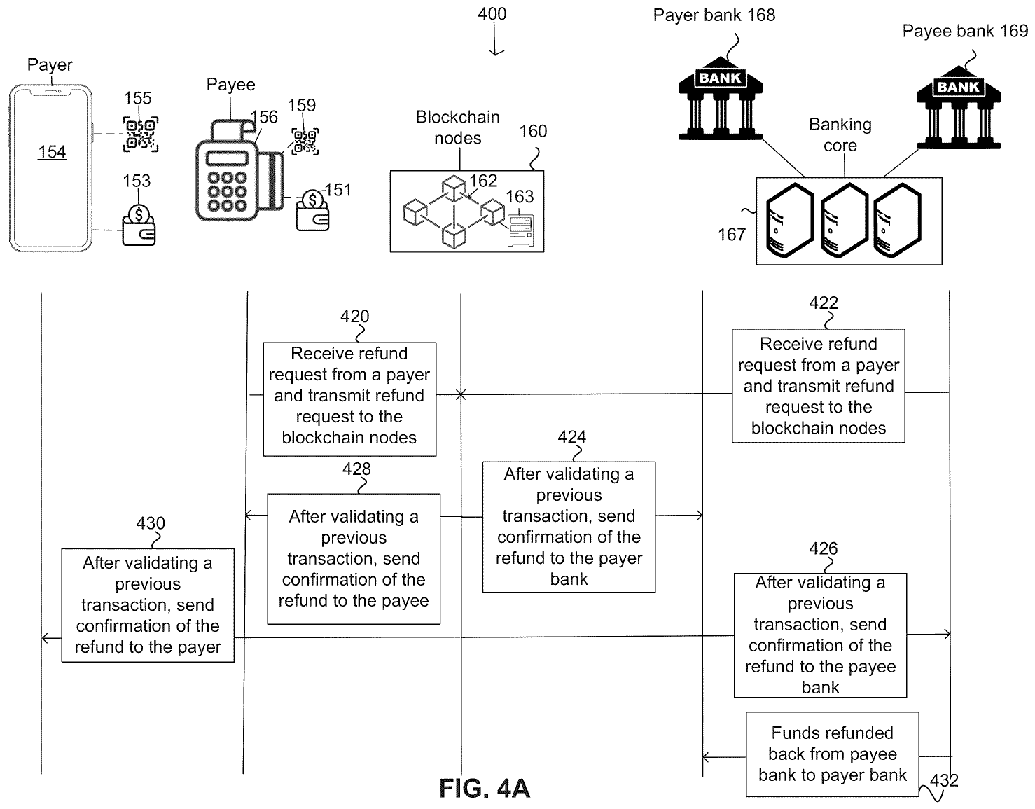

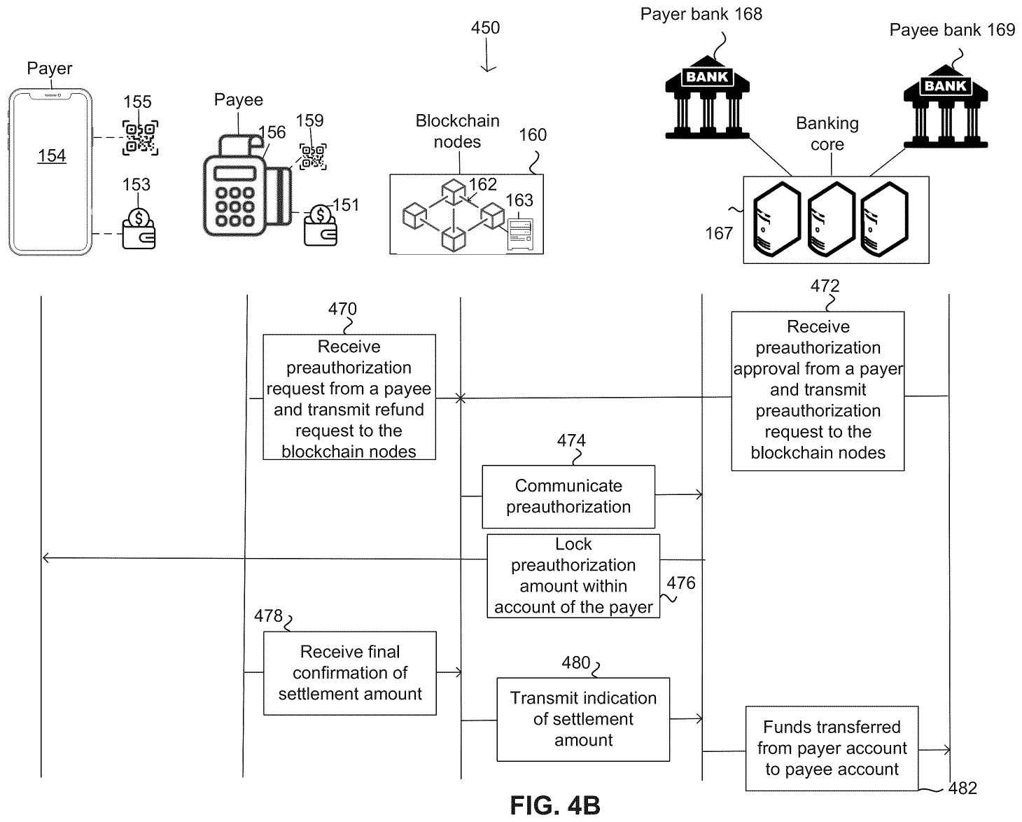

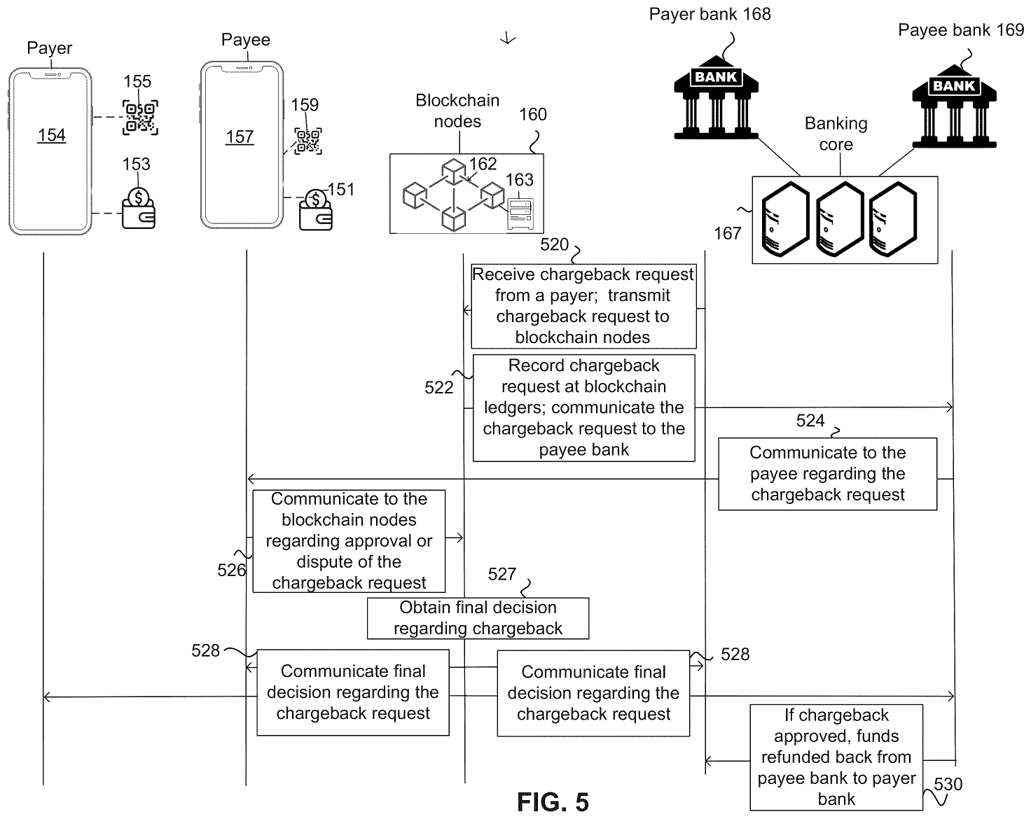

In some embodiments, not all parties, such as financial entities, may be fully integrated with the consolidated ecosystem 150. For banks that are fully integrated with the consolidated ecosystem 150, the blockchain nodes 160 may access the banking core 167 which performs authorization and settlement for that bank. If a bank is not fully integrated with or does not join the consolidated ecosystem 150, the blockchain nodes 160 may be unable to communicate with the banking core 167 corresponding to that bank. In other words, the blockchain nodes 160 may be unable to transmit or initiate payment, refund, and/or chargeback requests to the banking core 167 for authorization and settlement. Thus the blockchain nodes 160 may transmit requests only to a banking core corresponding to a fully integrated bank. As will be described in FIGS. 4A and 5, if only the payer bank is fully integrated with the consolidated ecosystem 150, then during a settlement of a payment, the payer bank pushes a payment to a proper destination. During a refund or a chargeback, if only the payer bank is fully integrated with the consolidated ecosystem 150, the payer bank pulls the refund or chargeback amount from the payee bank, through ACH, etc. Meanwhile, if only the payee bank is fully integrated with the consolidated ecosystem 150, then the payee bank can pull the payment from the payer bank, for example, via ACH pull in the event of a settlement. In the event of a refund or chargeback, if only the payee bank is fully integrated with the consolidated ecosystem 150, then the payee bank may push the refund or chargeback amount back to the payer bank.

The terminal 156 or the device 154 may transmit, to the one or more blockchain nodes 160 (e.g., one or more distributed blockchain nodes), an indication that a transaction has been initiated, via a data network or platform 158, which may be implemented in a same or similar manner as the data network and/or platform 108 in FIG. 1A. Although the terminal 156 and/or the device 154 is illustrated as directly being connected to the blockchain nodes 160, in other embodiments, the terminal 156 and/or the device 154 may only be indirectly connected to the blockchain nodes 160 or may be disconnected from the blockchain nodes 160. In other embodiments, the indication of the initiated transaction may be transmitted by the device 154 through the digital application 155 and/or the digital wallet 153. The blockchain nodes 160 may include one or more blockchain ledgers 162 and/or one or more node servers 163 that include hardware, software, and/or firmware configured and/or programmed to perform maintenance, recording, storage, routing, and processing functions associated with the one or more blockchain ledgers 162. The node servers 163 may include physical and/or virtual components or machines. The blockchain nodes 160 may be hosted by one or more network participants such as card or payment mechanism networks, card or payment mechanism issuers, banks (e.g., issuing or payer banks and/or merchant banks), credit unions, merchants, and/or payees. The blockchain nodes 160 receive and/or transmit updates because of seamlessly connecting to the different network participants. The blockchain nodes 160 may directly connect a payer and/or a payee, via the digital wallet 153 and/or the digital application 155, to any of the aforementioned different network participants, without additional intermediaries.

The blockchain nodes 160, as well as the digital application 155, may be restricted from storing any monetary value. In some embodiments, the blockchain nodes 160 may store biometric information and/or certain identification information of network participants for fraud prevention. The biometric information may include, for example, fingerprint information, retinal information, facial feature information, voice information, and/or other biometric features. In other embodiments, the biometric information and/or identification information may, additionally or alternatively, be stored elsewhere, such as within any of the devices 152. In some embodiments, at least a portion of the blockchain nodes 160 may be dynamically removed or inactivated, and/or additional blockchain nodes may be added or activated, depending on criteria such as a number of network participants and/or instantaneous processing requirements of the network participants, and/or instantaneous processing and/or storage loads on any of the blockchain nodes 160.

Recording transactions and/or other information within the blockchain nodes 160 may greatly reduce or eliminate dangers caused by security attacks or breaches at traditional card networks. Because the traditional, non-blockchain networks require numerous intermediaries, which may operate using different protocols, dangers of security attacks are further exacerbated because of numerous potential points of vulnerability. Security attacks at any one of the numerous intermediaries may have catastrophic consequences. Here, because the implemented blockchain nodes have immutable blockchain ledgers as well as other security features, the consolidated ecosystem 150 greatly reduces chances of security attacks.

The processing functions performed by the node servers 163 may include recording any initiated transactions within the one or more blockchain ledgers 162 and recording any confirmations of any initiated transactions. The recording of any initiated transactions and/or confirmed transactions may further include recording any contracts and/or contractual stipulations (e.g., smart contracts) associated with the transactions. In some embodiments, these contractual stipulations may include a return, refund, chargeback, and/or payment reversal policy. In other embodiments, if a transaction is a preauthorization or authorization hold, these contractual stipulations may include or specify one or more conditions, such as a number of days elapsing, for the preauthorization to be terminated or for settlement to occur.

The recording of the initiated transactions and/or confirmations may include encrypting and/or tokenizing payer and/or payee transaction data such as routing information, account information, payment amount, and/or other payment identification information, at a PoS or gateway level, or alternatively, at an issuance level, so merchants can authorize and settle directly with the payer bank 168. The record of the transaction, as captured by the tokenized information, may be sent to the banking core 167 over the blockchain 160 for fiat settlement, after the tokenized information is stamped by the merchant. Alternatively, an authorized receipt (e.g., a non-fungible token (NFT)) from a PoS terminal may be sent to the banking core 167 over the blockchain nodes 160. The authorized receipt may be stamped by the merchant. The recording may further include, obtaining associated data such as transaction data, account data, payment data, and/or security-related identification data of payers and payees. Because the data may be from multiple data sources, the data may originally have different formats and/or schemas. Thus, recording of the data may further include normalizing the data to have a consistent schema and/or format. For example, for credit card transactions, the data may be recorded in a format with standardized data fields to seamless integrate with downstream destinations such as the banking core 167. Additionally, the processing functions may include routing, in a point-to-point manner, any initiated transactions recorded within the blockchain ledgers 162 to a proper downstream destination. The proper downstream destination may include the banking core 167 for authentication, authorization, and settlement. The node servers 163 may determine a proper downstream destination based on a mapping between payment methods and specific systems that process or handle the respective payment methods. For example, a mapping may indicate that a first payment system, or a first settlement and authorization system within the banking core 167, processes payments for a first payment method (e.g., a first card), which a second payment system, or a second settlement and authorization system within the banking core 167, processes payments for a second payment method (e.g., a second card). The payment methods here refer to a payment card or other payment mechanism presented at the terminal 156 and/or at the mobile device 154. For example, if a card issued by entity A were presented at the terminal 156, then the node servers 163 may specifically route that initiated transaction to an issuing or payer bank (hereinafter “payer bank”) that processes card transactions for entity A. The node servers 163 may also generate updated records or ledgers of transactions and provide the updated records or ledgers to any network participants such as payers and/or payees. The updated records may be reformatted or normalized into different formats, such as a tabular format or a spreadsheet format. The node servers 163 may generate and provide transaction and/or accounting records, or a snapshot of the blockchain ledgers 162, to different network participants such as merchants, payers, or a retail management system, via periodic statements or in real time. The merchants may report the accounting records to other entities such as the Internal Revenue Service (IRS).

In some embodiments, the banking core 167 includes hardware, software, and/or firmware, manifested as one or more components including processors, digital cores, and/or platforms that authenticate, authorize, and settle transactions initiated from the terminal 156, the digital application 159, the digital wallet 151, the card 197, the mobile device 154, the digital application 155 and/or the digital wallet 153. The banking core 167 may be associated with and/or interfacing with a card issuer and/or provider of a payment mechanism used at the one or more devices 152, such as an issuer or payer bank or credit union. The banking core 167 may include or be linked with core providers such as Jack Henry®, FIS®, and/or Fiserv®, and/or other existing systems. In some embodiments, the banking core 167 may receive, from the blockchain nodes 160, an initiated and unconfirmed transaction recorded within the blockchain ledgers 162. In that scenario, the banking core 167 may confirm the transaction after authenticating and authorizing the transaction, and transmit the confirmation to the node servers 163 to update the blockchain ledgers 162 with the confirmation status. Following the confirmation, the banking core 167 may perform settlement and payment of the transaction by fiat or other currency transfer into an account of the payee, such as the payee bank 169 (e.g., a bank of the merchant). In other embodiments, the blockchain ledgers 162 may update a status of the transaction only after payment is received by the payee or the payee bank. The payment may be real-time, same-day, or next-day and may be performed via closed loop (payer and payee share the same bank, debit payer account and credit payee account), Real-Time Payments (RTP®), FedNow®, Automated Clearing House (ACH), other payment vendors such as Zelle®, application programming interfaces (APIs) such as Open Banking API. Other transactions such as cash advances and balance transfers may also be performed, and their statuses recorded using the blockchain nodes 160.

In this manner, the one or more devices 152 belonging to the payor and/or payee connect and communicate directly and seamlessly with the banking core 167 via the blockchain nodes 160, without additional intermediate entities. For example, the terminal 156 belonging to a payee and/or the mobile device 154 belonging to the payer may communicate directly with the banking core 167 that process transactions associated with a card or other payment mechanism used at the terminal 156. Even participants that are non-node-hosting (e.g., not hosting a blockchain node) may also achieve a seamless connection to the banking core 167, and/or to the blockchain nodes 160. These participants may include banking systems and management systems such as a card management system or other financial management system. The consolidated ecosystem 150 may be compatible with a common banking or management system, which handles different payment methods. Participants may be authorized and/or authenticated by the banking core 167, either through security-related identification information stored within the banking core 167 or within the blockchain nodes 160. As evident, the network participants communicate efficiently among one another due in part to instantaneous updating of transactions and transaction statuses at the blockchain nodes 160. As a result, actions or events from one network participant trigger events from other network participants without delays or with minimal delays, which improves upon traditional infrastructures for processing card payments.

The consolidated ecosystem 150 may further be associated with one or more machine learning or artificial intelligence (AI) components (hereinafter “AI components”) 161. The AI components 161 may be linked with the mobile device 154, the digital application 155, and/or the digital wallet 153 belonging to the payer, data network 158, blockchain 160, or non-blockchain (e.g., centralized) platform/network. In some embodiments, the AI components 161 may track payment activity using a unique identity token for each different payment method used. The AI components 161 may output specific rewards, promotions and/or incentives that are most closely tailored with the payment activity. For example, the AI components 161 may output a type, category, and/or amount of a reward, promotion or incentive, along with one or more times at which the reward is to be provided. For example, the AI components 161 may output a specific category of reward, promotion or incentive (e.g., product or service) that a payer is eligible for based on the past payment activity. Additionally or alternatively, the AI components 161 may output a time at which a reward, promotion or incentive is to be given, based on spending patterns. For example, if the AI components 161 detect that a particular payment method is used more frequently during a certain time within a year, a month, or a day, the AI components 161 may determine that the payer should receive a reward, promotion or incentive close to the frequently used times.

Going back to the operations of the blockchain nodes 160, FIG. 1C depicts exemplary diagrams illustrating initiating and confirmation of a transaction, and actions performed by downstream network participants in response to initiating and confirmation of a transaction. In FIG. 1C, one or more of the devices 152 may initiate a transaction at a time t₁. For example, the terminal 156, and/or the digital application 159, may receive or read a code from the digital application 155 or an input of the card 197, providing payment in response to a purchase, and indicating a specific payment method or account selected by the payer. The terminal 156 may also receive an indication of a transaction and payment amount via NFC. Alternatively, the mobile device 154 may receive or read a code from the terminal 156 or another device connected with a payee, to indicate initiation of a transaction and/or agreement to a transaction. Therefore, after confirmation is received from the payer on the digital application 155 or from the payee on the digital application 159, either the digital application 155 of the mobile device 154 or the digital application 159 of the terminal 156 may initiate the transaction.

In some embodiments, the terminal 156 may determine that the payment method presented by the payer (e.g., the card 197, the digital wallet 153 and/or the digital application 155) is valid and/or has sufficient funds. In other embodiments, the terminal 156 may instead obtain this determination from the node servers 163 or from the banking core 167 which provides both authorization and settlement. If payment or transaction information, including available balances, is stored within the blockchain nodes 160, the node servers 163 may retrieve the payment information and transmit, to the terminal 156 or the digital application 159, an indication of whether the presented payment method is valid and/or has sufficient funds. Upon determining or obtaining the validity and/or the sufficiency of funds of the presented payment method, the terminal 156 or the digital application 159 may prompt the payer for an approval of the initiated transaction. The payment confirmation is first done by payer and payee (e.g., approved by a payer and/or payee on their respective devices) and then authorized by the banking core 167 or the blockchain nodes 160. The terminal 156 or the digital application 159 and/or the blockchain nodes 160 may approve the payment method via biometrics, passcodes, geolocation-based authentication, two-step verification or two-factor authentication, and/or other security mechanisms such as Payment Card Industry Data Security Standards (PCIDSS). Approval of the initiated transaction may be provided via biometrics, submission of a signature, pressing an approval button, or other approval mechanisms on the digital application 155 or at the terminal 156 or the digital application 159 at a time t₂. Additionally or alternatively, the payee may also approve the initiated transaction through the terminal 156 via similar mechanisms. Following the approval, the node servers 163 may obtain an indication of the approval by the payer and/or the payee, and add a record 170 in the blockchain ledgers 162 to record a transaction. In some embodiments, this transaction may be unconfirmed and await confirmation by the banking core 167. The record 170 of the unconfirmed transaction may include details that were transmitted to the blockchain nodes 160 by the terminal 156, the digital application 159, the digital wallet 151, the mobile device 154, the digital application 155, or the digital wallet 153. The details may include a payment amount, payer information, and transaction information such as account information and routing information of an account or bank associated with the payee. As previously alluded to, the node servers 163 may encrypt and/or tokenize payer and/or payee transaction data such as routing information, account information, and/or other payment identification information, such as at a point of sale (PoS) or gateway level. The node servers 163 may back up or export the transaction data to a separate database system.

Next, the node servers 163 may transmit an indication of the transaction to the banking core 167. The node servers 163 may transmit the indication to this destination because the banking core 167 specifically map to a payment method used at the terminal 156. The banking core 167 may authenticate, authorize, and settle the confirmed transaction with a bank or an account corresponding to the payer. In some embodiments, as illustrated in FIG. 1B, recording a confirmation within the blockchain ledgers 162 may require confirmation from the banking core 167, and/or from a third-party system besides the devices 152. For example, in FIG. 1C, the banking core 167 may confirm the initiated transaction by authenticating, authorizing, validating and initiating a debit or transfer from the payment method associated with the initiated transaction, at time t₃. In other embodiments, confirmation of actual payment to the payee or the payee's bank is required in order for a transaction to be recorded as confirmed on the blockchain ledgers 162.

Following the confirmation by the banking core 167, the node servers 163 may record a confirmed transaction (e.g., within the record 170) within the blockchain ledgers 162 by adding a block 181. The block 181 may also include or be linked with one or more contracts 182 and/or contractual stipulations, which may specify conditions for a return, refund, chargeback, and/or reversal of payment. The contracts 182 may be evaluated, by the node servers 163, against any conditions that occur. For example, if the payer seeks to return a product, then the node servers 163 may determine whether the return request has been made within a window of time permitted according to the contracts 182.

As evident, the blockchain nodes 160 efficiently store and record statuses of transactions. Network participants within the consolidated ecosystem 150 efficiently receive updates of new transactions and/or changes in statuses of transactions, such as an initiated transaction being confirmed. As a result, settlement and resolution of transactions occur without delay, in real-time or near real-time.

To further enhance the versatility of the consolidated ecosystem 150, blockchain nodes or blockchains may be distributed through the consolidated ecosystem 150 in different configurations. For example, blockchains may be distributed or organized according to criteria such as sizes of payees (e.g., merchants), types or categories of payees, and/or sizes of issuing banks and/or merchant banks. For example, blockchains may be distributed such that one blockchain is dedicated to large merchants (e.g., exceeding a specific revenue, number of physical locations, or amount of inventory or customers) while a different blockchain is dedicated to small merchants. More specifically, one blockchain interfaces with, records, stores, routes, and processes transactions from large merchants while the different blockchain interfaces with, records, stores, routes, and processes transactions from small merchants. In some embodiments, a size of a merchant may be defined based on any criteria, such as revenue, demand, production, and/or inventory. Additionally or alternatively, one blockchain may be dedicated to online merchants while another blockchain may be dedicated to offline merchants. In some embodiments, a single blockchain may be dedicated to a particular merchant, merchant's bank, or payer bank. In some embodiments, a single blockchain may be dedicated specifically to different types of financial institutions. For example, one blockchain may be dedicated to banks and a different blockchain may be dedicated to credit unions. As another example, one blockchain may be dedicated for each geographical region such as a state, a group of states, a county, or a group of counties.

As another example, certain blockchains may be configured based on criteria such as security. In particular, some blockchains may be dedicated to network participants that have heightened or stricter security requirements. Those blockchains may store the additional security information associated with the heightened security requirements. In such a manner, each blockchain may be adaptively configured depending on requirements or characteristics of one or more network participants. This adaptive configuration of each blockchain represents an improvement in computing technology by addressing the needs of each network participant, thereby improving processing of each network participant as well as downstream processing (e.g., at the banking core 167).

As previously alluded to, each blockchain node may be hosted by one or more of different network participants, such as processing systems associated with merchants, issuers, banks or credit unions, payment entities, PoS vendors, card networks, banking system providers, or any combination of the different network participants. Together, and with a payer bank and/or credit unit, the blockchain nodes provide a guarantee of payment to the payee. For example, one blockchain node may be hosted by one or more credit unions, and a second blockchain node may be hosted by one or more banks and/or merchants. Moreover, an entire blockchain may be hosted by a consortium of participants. Each blockchain node may be operated by multiple node servers for load balancing, redundancy and backup purposes. For example, each blockchain node may perform maintenance, storage, recording, and/or processing tasks within a blockchain or blockchain network. In some embodiments, a number of node servers corresponding to a particular blockchain node may depend on different factors such as computing processing requirements at the particular blockchain node, and/or amount of data stored within the particular blockchain node and/or within associated ledgers. For example, if any of computing processing requirements, or amounts of data stored, exceed a threshold, then one or more redundant node servers may be added. For example, the node servers may include physical or virtual machines. In some embodiments, one entity may host a server that operates on multiple blockchain nodes within a same or different blockchain. In some examples, if one node server with a particular blockchain node fails, or otherwise becomes comprised in its performance, then other backup servers within the blockchain node may take over and maintain complete functionality of that particular blockchain node. Additionally, blockchain networks may be added or replicated to provide backup functionality in an event that an existing blockchain network failed or otherwise became comprised in functionality or performance. For example, a backup blockchain network may be initially in an inactive status but toggled or switched to an active status upon failure or reduced functionality of a primary blockchain network. In some embodiments, failure or reduced functionality of a primary blockchain network may be detected by the backup blockchain network, a node server, or a different processor or controller within the consolidated ecosystem 150. The failure may be detected based on an increased latency, reduced data throughput, and/or reduced bandwidth, among other factors. The consolidated ecosystem 150 may also support addition, removal, and/or reconfiguration of blockchain nodes depending on changing conditions within the consolidated ecosystem 150. Additionally, blockchain nodes can be merged together or split up depending on various criteria, such as loading conditions (e.g., a computing and/or storage load). In some embodiments, a number of blockchain nodes corresponding to a particular blockchain may depend on one or more entities hosting a blockchain.

In some embodiments, recording of transactions may be toggled between on-chain recording and off-chain recording, based on transaction characteristics such as transaction amounts, security requirements of a transaction, an identity of a payer or payee, a priority of a payer or payee, and/or a frequency of the recording of the transactions. On-chain recording may include recording directly on the blockchain network (e.g., the primary blockchain network). Off-chain recording may include recording on a side blockchain network and/or centralized network. For example, when the frequency of transactions has increased to above a threshold frequency, and/or if congestion of the primary blockchain network has increased to above a threshold congestion extent, a portion of the transactions such as transactions corresponding to a smaller amount and/or transactions having a less stringent security requirement may be routed off-chain. In some embodiments, any transactions recorded off-chain may be transferred on-chain depending on conditions within the blockchain network (e.g., when a level of congestion within the blockchain network has decreased).

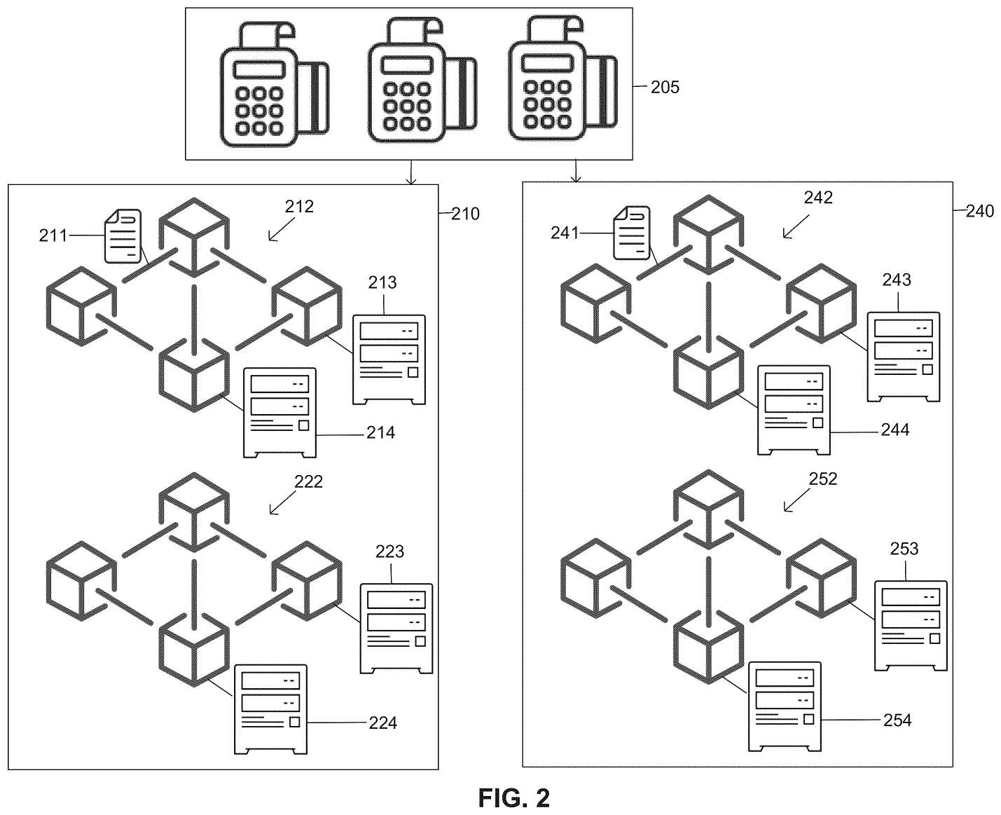

FIG. 2 illustrates an exemplary distribution or configuration (hereinafter “configuration”) of blockchains or blockchain networks (hereinafter “blockchains”), in view of some of the concepts presented above. Here, blockchains 210 and 240 may be dedicated to a first entity, first entity type, or first entity category (e.g., large merchants), while other blockchains (not shown) may be dedicated to a second entity, second entity type, or second entity category (e.g., small merchants). The blockchains 210 and 240 may be dedicated to performing tasks initiated by one or more mobile devices 205 belonging to the first entity or belonging to any other party participating in a transaction. These tasks may include processing tasks that are triggered in response to an indication, such as an initiation or confirmation of a transaction, from one of the mobile devices 205.

In some embodiments, the blockchains 210 and 240 may be redundant. The blockchain 210 may have blockchain nodes, including, for example, blockchain nodes 212 and/or 222. The blockchain 240 may have blockchain nodes, including, for example, blockchain nodes 242 and/or 252. Only two blockchain nodes are illustrated in each blockchain for simplicity, but it is understood that each blockchain may have any number of blockchain nodes. Each of the blockchain nodes 212, 222, 242, and 252 may be associated with multiple servers (e.g., node servers 213, 214 of the blockchain node 212, node servers 223, 224 of the blockchain node 222, node servers 243, 244 of the blockchain node 242, node servers 253, 254 of the blockchain node 252) for redundancy, and to guarantee availability of the blockchain node.

In some embodiments, if the blockchain 240 is redundant, the blockchain 240 may also replicate and/or store any records generated by the blockchain 210. For example, a new record 211 within the blockchain node 212 of the blockchain 210 may be replicated as a new record 241 within the blockchain node 242 of the blockchain 240 for redundancy and backup. In other words, the new records 211 and 241 may have same information. Therefore, any update to a record within the blockchain nodes 212 may be propagated to and/or synchronized with the blockchain nodes 242 by one or more of the node servers 213, 214, 223, 224, 243, 244, 253, and/or 254.

In some embodiments, the one or more mobile devices 205 may be implemented as the terminal 156 of FIGS. 1B-1C, which may include a mobile device. Thus, any functionalities previously attributed in FIGS. 1B-1C to the terminal 156 may also be applicable to the one or more mobile devices 205. In some embodiments, any of the blockchain nodes 212, 222, 242, 252 may be implemented as the blockchain nodes 160 of FIGS. 1B-1C. Any of the node servers 213, 214, 223, 224, 243, 244, 253, and/or 254 may be implemented as the node server 163 of FIGS. 1B-1C.

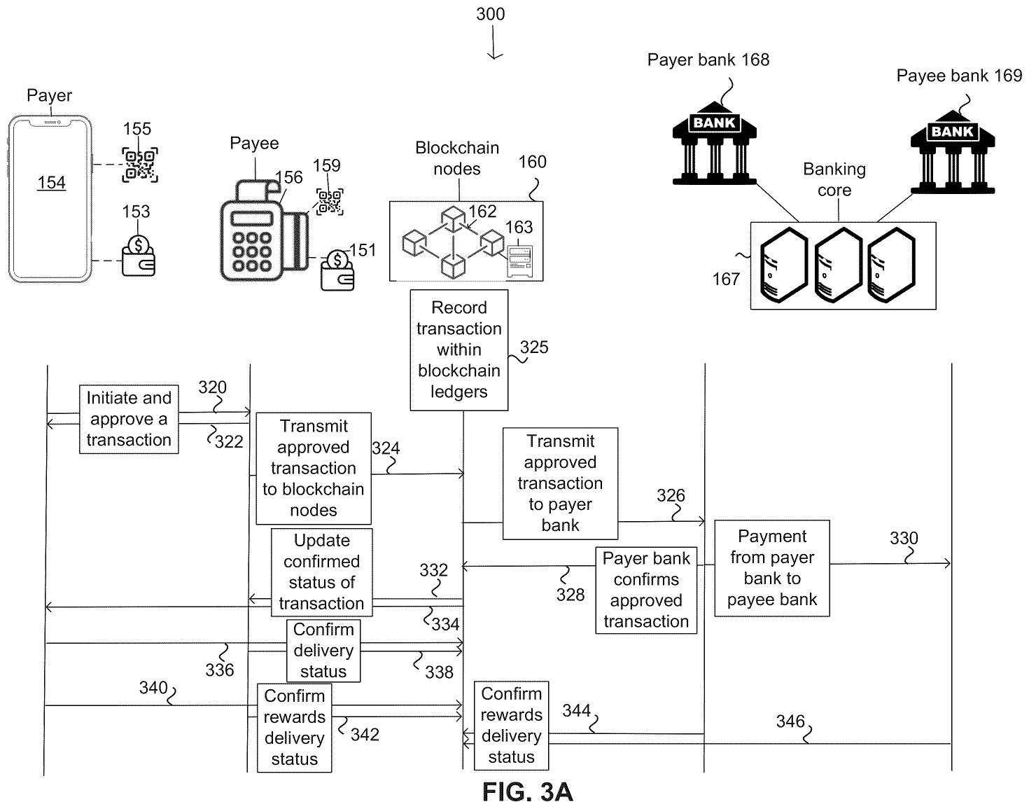

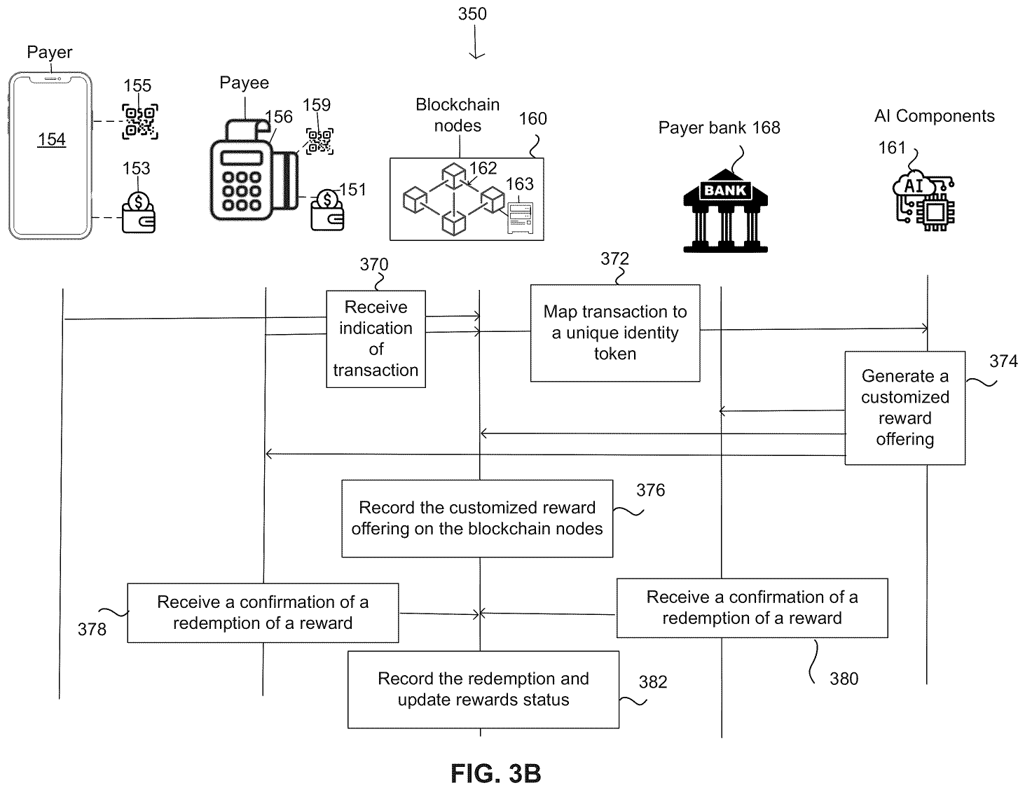

A schematic illustration that further elucidates the collaboration among the multiple network participants is shown in FIG. 3A. FIG. 3A illustrates a payment process 300 among network participants and entities coordinated by the one or more blockchain nodes 160, consistent with the previous description in FIGS. 1B-1C. The network participants include a payer associated with and/or interfacing with the mobile device 154, a payee associated with and/or interfacing with the terminal 156, which may be a mobile device, the payer bank 168 and/or a the payee bank 169 associated with and/or interfacing with the banking core 167, as illustrated in FIG. 1C. First, in step 320, the payer initiates a transaction with the payee via the digital application 155 and/or the digital wallet 153, which is hosted on the mobile device 154. The payer may be authenticated via biometrics, device verification, geolocation, digital signature, passcode, multi-step verification, and/or other fraud prevention mechanisms. The payer may scan or input a code (e.g., a QR code or an alphanumeric code) of the payee from the terminal 156, which may be connected to a management system (e.g., retail or inventory management system) of the payee. In some embodiments, the code may include a payment amount. In other embodiments, the payer may, in addition to scanning the code, input a payment amount or an additional tip. The payer may also use other methods besides scanning a code from the terminal 156. These other methods include using NFC and inputting a payment amount or a tip. Alternatively, in step 322, the payee, instead of the payer, may initiate a transaction by scanning or inputting a code of the payer from the mobile device 154 using the terminal 156 which may or may not include or be connected to a scanning device using NFC. The payee may alternatively input a payer code and/or a transaction amount including any tips. The payer selects a proper account (e.g., a loan account, a line of credit, an equity line, a debit or credit card, and/or any other account) from which to debit funds and approves the transaction via approval mechanisms such as biometrics or other pass codes. The payee may confirm the transaction, with or without a passcode and/or with biometrics. In some embodiments, the initiating of the transaction in step 120 includes transmitting a transaction request using a private key (e.g., the payer's private key) to sign the transaction, and encrypting the transaction using a public key (e.g., the payee's public key). Along with the transaction data, the private key creates a digital fingerprint. In some embodiments, the private key and the public key may not need to be inputted by the payer and the payee, but is instead encoded within respective scanned codes and/or automatically transmitted upon the initiating, and/or approval of the transaction.

Following approval, in step 324, the terminal 156 or the mobile device 154 transmits an indication of the approval to the blockchain nodes 160. In step 325, the blockchain nodes 160 may verify an account and/or a sufficient balance of the account of the payer to be debited. In some embodiments, the blockchain nodes 160 may validate the transaction using the public key and ensure that the transaction data is untampered using hashing. In some embodiments, the blockchain nodes 160 may confirm a block validity which includes verifying that the transaction data conforms to size constraints and/or cryptographic rules. In some embodiments, checking of the balance may be via the blockchain ledgers 162, which may store balance information and logs of previous transactions. If the account is verified and the balance is verified to be sufficient, the blockchain nodes 160 may record a transaction, which may be unconfirmed, within the blockchain ledgers 162. In some embodiments, the blockchain nodes 160 may combine the public key and the encrypted signature to verify a match with the requested transaction. The blockchain nodes 160 may also verify that the public key matches the digital wallet from which the transaction is occurring. The blockchain nodes 160 may also perform hashing to ensure that the transaction data is untampered. The blockchain nodes 160 may also validate a format of the requested transaction to ensure conformance with size constraints and/or cryptographic rules.

In step 326, the blockchain nodes 160 may propagate or transmit the transaction, including payment amount and a destination of the payment, directly to the banking core 167 associated with the payer bank 168. However, if the blockchain nodes 160 determine that an account is invalid (e.g., closed or locked) or that the balance is insufficient, the blockchain nodes 160 may notify the payer and payee. In other embodiments, the blockchain nodes 160 themselves may not determine a validity of the account and/or whether a balance is sufficient, but rather, receive, from the banking core 167, an indication of whether the account is valid and/or whether the balance is sufficient. The transaction may be reattempted a given number of times. The blockchain nodes 160 can also transmit payment information to the banking core 167 for authorization and settlement.

In step 328, the banking core 167 may confirm a status of the transaction and transmit an indication of the confirmation to the blockchain nodes 160. The banking core 167 may authorize the transaction and debit a selected payment account or method. If the banking core 167 is associated with a traditional credit card account, the banking core 167 may settle the balance directly with the merchant.

The blockchain nodes 160 may record a confirmation status of the transaction within a new block (e.g., within the record 170 of the block 181 of the blockchain ledgers 162 as illustrated in FIG. 1C) either after the confirmation of the transaction by the banking core 167, or after payment is completed to the payee or the payee bank (e.g., the merchant bank). In step 330, the banking core 167 or the payer bank 168 may authorize and schedule a payment to be directed to the payee bank 169, or the banking core 167 associated with the payee bank 169. In some embodiments, as explained above, authorization and settlement may be combined into a single step. The payment may commence with the generating of a payer bank-payee specific token (e.g., an issuer-specific credit/debit token) within the blockchain nodes 160. This payer bank-payee specific token represents an authorization by the payer, an obligation for the payer bank to transmit a specified payment amount to the merchant's or payee's bank, and a proof of payment. The payer bank-payee specific token may be an instrument for merchants or their acquiring banks to directly settle with the payer bank 168 and/or card issuers. The payer bank-payee specific token may be specific for a given transaction between the payer bank and the payee. Therefore, for a different transaction between the payer bank and the payee, a different token is created. The payment may be made via one or more protocols such as RTP, closed loop debit/credit (the payer bank 168 and the payee bank 169 share the same bank), ACH, FedNow®, or using external methods. The payment may be transmitted in real-time, in batches, or at defined periods. In a closed loop, if the payer bank and the merchant's bank are the same, then an account belonging to the payer may be debited while an account belonging to the payee may be credited. In some embodiments, payments from the payer bank 168 may include payments for the transaction directed to the payee bank 169, which take into account any discounts while excluding processing fees. These payments may be separate from issuer and processing fee payments which may be made to a settlement house or other entities. After a transaction, each payer may provide a rating score for a merchant. This rating score may be programmed or encoded into a QR or alphanumeric code associated with the merchant or stored in the blockchain nodes 160 or elsewhere to be recalled or retrieved, and may be provided upon scanning or inputting of the code.

Once the transaction is confirmed within the blockchain ledgers 162, the blockchain nodes 160 may, through its connections, provide updates to network participants and/or external entities regarding the confirmed status of the transaction. For example, in step 332, the blockchain nodes 160 may transmit a status of the completed transaction to the terminal 156 and/or other systems associated with the merchant, such as digital applications, digital wallets, and management systems. In step 334, the blockchain nodes 160 may transmit the confirmed status to the mobile device 154, the digital wallet 153, and/or the digital application 155. The blockchain nodes 160 may transmit the confirmed status to other participants within a banking system. In some embodiments, in steps 336 and 338, the payer via the mobile device 154, and/or the payee via the terminal 156, may confirm a status of delivery of goods and/or services and transmit the confirmation of the delivery to the blockchain nodes 160, which record the confirmation status of delivery within the blockchain ledgers 162.

Additionally, any rewards (e.g., cash back, points, mileage, discounts) or promotions may be delivered to the payer from the payee bank or from the payee, and successful delivery of the rewards or promotions may be recorded onto the blockchain ledgers 162. For example, in steps 340, 342, 344, and 346, any of the payer via the mobile device 154, the payee via the terminal 156, the payer bank 168 via the banking core 167, and/or the payee bank 169 via the banking core 167, may transmit or confirm a status of rewards or promotions to the blockchain nodes 160. The blockchain nodes 160 record the status of rewards or promotions within the blockchain ledgers 162. In some embodiments, the blockchain nodes 160 also store criteria and/or requirements of rewards or promotions, for example, within a contract. Prior to delivery of rewards or promotions, the blockchain nodes 160 may evaluate transactions to determine whether a specific transaction or a group of transactions satisfy the criteria for rewards or promotions. Upon determining satisfaction of the criteria, the blockchain nodes 160 may transmit to one or more network participants, such as the payee or the payee bank 169, an indication that rewards or promotions are to be delivered.

Rewards or promotions may be offered by financial institutions (e.g., the payer bank 168) and/or by payees (e.g., merchants). In some embodiments, banks or credit unions may offer payers rewards in accordance with a loyalty program which may be programmed onto the blockchain nodes 160. Meanwhile, merchants may offer a merchant specific loyalty program or promotion which may also be programmed onto the blockchain nodes 160. In some embodiments, points, offerings, and/or redemptions may be recorded at the digital application 155 and/or the digital application 159, banking applications, at management systems of the payees, at third party datastores, and/or within the blockchain nodes 160. In some embodiments, amount of rewards or promotions obtained may be converted into points and/or discounts.

In some embodiments, the AI components 161, as shown in FIG. 1B and in FIG. 3B, may analyze previous spending behavior and/or patterns to generate or output customized offerings, including type or category of reward, promotion, and/or time at which a reward or promotion is to be provided. For example, if the AI components 161 determine that a particular payment method is frequently used during a certain range of times to purchase a particular category of product, then the AI components 161 may generate an output of a reward or promotion related to that particular category of product to be offered at around the range of times. For example, if a customer uses a payment method to purchase specific items or a classification of items at a certain threshold frequency during a specific season, such as Christmas every year, then the AI components 161 may generate and/or infer an output of a reward or promotion within a same category of items at or near that season, such as near Christmas time.

The AI components 161 may be trained to output customized offerings using one or more sets of training data, and/or may be trained during one or more training sequences. Training data may include scenarios that map transaction histories to rewards, or that map transaction histories to promotions. For example, the AI components 161 may initially be trained using first training data, and subsequently trained using second training data. In some embodiments, the first training data may include a training dataset with examples or scenarios of correctly mapped rewards or promotions to transaction histories, and/or examples or scenarios of incorrectly mapped rewards or promotions to transaction histories. In some embodiments, the second training data may be generated or otherwise obtained based on incorrectly inferred rewards or promotions by the AI components 161. In such a manner, the AI components 161 may be iteratively trained to improve inferences or predictions.

FIG. 3B illustrates a rewards or promotion process 350 among network participants and entities coordinated by the one or more blockchain nodes 160, consistent with the previous description in FIGS. 1B-1C. Although an implementation involving AI components is illustrated, in other implementations, the rewards or promotion process may not require AI components. In step 370, the blockchain nodes 160 may receive an indication of a transaction from the payee (e.g., at the terminal 156 via the digital application 159) or the payer (e.g., at the device 154 via the digital application 155). In step 372, the blockchain nodes 160 may map the transaction to a unique identity token, which indicates a specific payment method. Each payment method may map to a different unique identity token. Therefore, the blockchain nodes 160 track a history and a pattern of payments made according to different payment methods. Transaction details, including the unique identity token, a type or category of product or service purchased, and/or an amount of the purchase, may be routed to the AI components 161. In step 374, the AI components 161 may generate a customized reward or promotion offering based on the history and pattern of purchases made, for a given unique identity token. The customized reward or promotion offering may be transmitted, for example, via one or more APIs, to any of the network participants such as the payee and/or the payer bank. The customized reward or promotion offering may also be routed to the blockchain nodes 160, which may record the customized reward or offering in step 376. In steps 378 and 380, a reward or promotion may be redeemed either at the terminal 156 (e.g., a PoS terminal) or at a bank. The redemption of the reward or promotion, once confirmed, may be transmitted to the blockchain nodes 160. In step 382, the blockchain nodes 160 may authorize the rewards or promotion redemption with the merchant or with the payee bank 169, record the redemption and update a rewards or promotion status, for example, by deducting a rewards balance, which may be stored, for example, within the blockchain ledgers 162.

In some embodiments, rewards and/or promotions may include rebates, discounts, and/or coupons. For example, merchants may transmit promotion details either to the digital application 155 or the digital wallet 153 of the payer, an application or wallet connected to a financial institution, or a third-party application or wallet. The promotion details may indicate targeted entities and specific items or categories of items, along with times at which the promotions are to be provided. In some embodiments, the rewards or promotions may be offered or presented when a payer is presenting the digital wallet 153 and/or the digital application 155 at a PoS terminal (e.g., the terminal 156 or a mobile application or device). In a first scenario, if a payer uses a blockchain card for a transaction, the digital wallet 153 and/or the digital application 155 may display any rewards being offered. The payer may confirm redemption of a reward. The blockchain nodes 160 may authenticate the reward with an issuing bank, credit union, merchant, or a third-party application or wallet operator. For example, the blockchain nodes 160 may confirm a validity of the reward and that a rewards balance is sufficient for redemption of the reward, and/or by receiving a confirmation from the rewards provider (e.g., the merchant or the bank). The blockchain nodes 160, merchant, bank and/or credit union may record the redemption of the reward and update a rewards balance.

In a second scenario, if a payer uses a traditional credit or debit card, other payment mechanism, or cash, when the payer presents the digital application 155 and/or the digital wallet 153, eligible rewards may be displayed on the digital application 155 and/or the digital wallet 153. Eligible rewards may be encapsulated by codes such as QR codes. The QR codes may be scanned for redemption. The merchant, using the digital application 159, may scan a QR code. The blockchain nodes 160 may receive an indication that the QR code has been scanned. The blockchain nodes 160 may authorize the redemption with a payer bank, payee, payee bank, other financial institutions, or a third-party application or wallet provider. The merchant may confirm the redemption, deduct the amount of the redemption from an original purchase amount, and settle the remaining balance, using either the non-blockchain ecosystem 100 or the consolidated ecosystem 150. In other embodiments, the merchant may charge the original amount and settle the full amount, while confirming the redemption. The blockchain nodes 160 may tokenize the promotion information and transmit the redemption information to a payer bank or a third-party application or wallet provider. The payer bank, or a third party, may draft, via a closed loop process (payer and payee share the same bank), ACH, FedNow, or RTP, the rewards redemption amount from an account associated with a payee bank and credit an account of the payer bank. Following the redemption, if a reward has been completely redeemed, the reward may be deleted from the digital application 155 and/or the digital wallet 153. The redemption of the reward may be recorded on the blockchain nodes 160, as well as on the digital application 159 or an application associated with a bank.

Other transactions, including refunds and/or reversals of payments, may also be performed within the consolidated ecosystem 150 and recorded on the blockchain nodes 160, as illustrated in FIG. 4A. FIG. 4A is a schematic illustration that depicts a refund or payment reversal (hereinafter “refund”) process 400 among network participants and entities coordinated by the one or more blockchain nodes 160, consistent with the previous description in FIGS. 1B-1C. The network participants and entities include a payer associated with the mobile device 154, a payee associated with the terminal 156, which may include a mobile device, the banking core 167 which may be associated with the payer bank 168 and/or the payee bank 169.

First, in step 420 or in step 422, the payee, or the payee bank 169, receives a refund request from a payer, selects a given transaction or payment record, approves the refund request, and transmits the approved refund request to the blockchain nodes 160. Alternatively, the payee may initiate a refund request. The blockchain nodes 160, in particular, the node servers 163, may retrieve a previous transaction, corresponding to the refund request, stored within one or more blocks of the blockchain ledgers 162. For example, if the refund request seeks to return goods A, then the previous transaction is one in which goods A were purchased. The blockchain nodes 160 may validate the previous transaction. In some embodiments, the blockchain nodes 160 may evaluate a contract associated with the previous transaction to verify whether conditions indicated by the contract are satisfied. Once the blockchain nodes 160 validate the previous transaction and/or verify that conditions are satisfied, the blockchain nodes 160 may transmit, to any or all of the network participants, a confirmation of the refund, in steps 424, 426, 428, and/or 430. In some embodiments, the blockchain nodes 160 may update the blockchain ledgers 162 to record the refund once confirmed by the blockchain nodes 160. In other embodiments, the blockchain nodes 160 may update the blockchain ledgers 162 once funds are restored to a correct account of the payer or the payer bank 168, which occurs in step 432 via the banking core 167. In some embodiments, the restoring of the funds may involve a token generating process at the blockchain nodes 160 to generate a payee bank-payer bank specific token representing an obligation of the payee bank 169 to restore the funds to the payer bank 168. The token generating process here may be same or similar in principle as the token generating process illustrated in step 330 of FIG. 3. In some embodiments, the payer bank 168 may obtain funds from the payee bank 169 via methods such as an ACH pull, FedNow pull, or RTP and pull or closed loop (same bank debit and credit). The payer bank may send a double confirmation to the mobile device 154 via text or two-factor authentication (2FA) regarding the refund. In other embodiments, the payee bank 169 may initiate transfer of funds to the payer bank 168.

In some embodiments, the payer bank 169 or the payee bank 168 may not be fully both integrated with the consolidated ecosystem 150. If only the payer bank 169 is fully integrated with the consolidated ecosystem 150, then during a settlement of a payment, the payer bank 169 pushes a payment to a proper destination. Meanwhile, if only the payee bank 168 is fully integrated with the consolidated ecosystem 150, then the payee bank 168 can pull the payment from the payer bank 169, for example, via ACH pull in the event of a settlement.

Meanwhile, a reversal may be implemented in a similar manner as a refund described above, except that in a reversal, a transaction has not yet been settled and may still be pending. A payment amount may be locked. The payee may cancel a payment prior to settlement which unlocks the payment amount. In this scenario, the blockchain ledgers 162 may record a transaction that has not been settled yet. The payee may cancel the transaction, thereby reversing the pending payment. The blockchain nodes 160 may obtain an indication of the cancellation prior to settlement and record the cancellation. The blockchain nodes 160 may transmit an update indicating the cancellation status to the payer bank, and/or to the digital application 155. In some embodiments, the blockchain nodes 160 may transmit the update to the payee bank, or the banking core 167 associated with the payer bank 169 and the payee bank 168, respectively. The banking core 167 may credit the amount of the payment back to the account of the payer. Once the payment has been credited back, the blockchain nodes 160 may receive a status update, either from the banking core 167, the payer bank 169, or the payee bank 168. The blockchain ledgers 162 may update the record that the payment has been cancelled and credited back.

In the event of a preauthorization, the payee may preauthorize and lock an amount of a payment from an account of the payer, and the payee may settle on a final amount once the amount is confirmed. A preauthorization may be performed using a smart contract. FIG. 4B is a schematic illustration that depicts a preauthorization process 450 among network participants and entities coordinated by the one or more blockchain nodes 160, consistent with the previous description in FIGS. 1B-1C. The network participants and entities include a payer associated with the mobile device 154, a payee associated with the terminal 156, which may include a mobile device 156, the payer bank 168, the payee bank 169, and the associated banking core 167.

First, in step 470 or in step 472, the payee or the payer may initiate or approve a preauthorization. The preauthorization request and/or approval may be transmitted to the blockchain nodes 160. The blockchain nodes 160 may obtain and/or store a smart contract (e.g., the contract 182 of FIG. 1C) associated with the preauthorization. This smart contract may stipulate terms and conditions such as how long the preauthorization lasts before falling off, and/or a final confirmed amount which may be different from the preauthorization amount. In step 474, the blockchain nodes 160 may communicate with the banking core 167, the payer bank (e.g., the payer bank 168 of FIG. 1B) or the payee bank (e.g., the payee bank 169 of FIG. 1B), regarding the preauthorization. In step 476, the banking core 167, or the payer bank 168, may lock (e.g., restrict from usage or temporarily deduct from an available balance) the preauthorization amount from an account of the payer at the payer bank. For example, if the preauthorization amount is $100, then the banking core 167—or the payer bank 168 may lock $100 within the account of the payer. In some embodiments, the preauthorization amount may not be credited to an account of the payer until final confirmation from the payer and/or from the payee. In step 478, the payee may decide and confirm a final settlement amount and transmit the final settlement amount to the blockchain nodes 160. In step 480, the blockchain nodes 160 may transmit an indication of the final settlement amount to the banking core 167. In step 482, the banking core 167 may transfer the final settlement amount from an account within the payer bank 168 to an account within the payee bank 169. Alternatively, if no final confirmation of a settlement amount is transmitted to the blockchain nodes 160 in step 478, and a threshold period of time has elapsed since initiation of the preauthorization, the blockchain nodes 160 may transmit an indication to the banking core 167 or the payer bank 168 that the preauthorization has fallen off. The previous lock may then be removed.

Overall, with the consolidated ecosystem 150, refunds that would take days under the traditional card architecture are now performed instantaneously, or nearly instantaneously, due to improvements in computing technology of the consolidated ecosystem 150.

FIG. 5 is a schematic illustration that depicts how a chargeback 500 is handled among network participants and entities coordinated by the one or more blockchain nodes 160. The network participants and entities include a payer associated with the mobile device 154 associated with a payer, a payee associated with a device 157, which may include a mobile device, the payer bank 168, the payee bank 169, and the associated banking core 167. The device 157 may be any suitable computing device containing hardware, software, and/or firmware that is configured to process transactions, receive and transmit updates to the blockchain nodes 160, and communicate with other network participants. The device 157 may be implemented in conjunction with or as an alternative to the terminal 156 previously illustrated in FIGS. 1B and 1C.

Starting from step 520, the payer communicates to the payer bank that a chargeback is desired. The payer bank 168 may initiate the chargeback request and communicate the chargeback request with the blockchain nodes 160. At step 522, the blockchain nodes 160 may record the chargeback request at the blockchain ledgers 162, and communicate the chargeback request to the payee bank 169. Next, at step 524, the payee bank 169 may inform the payee regarding the chargeback request. At step 526, the payee may approve or dispute the chargeback request and communicate to the blockchain nodes 160 regarding the approval or dispute. Additionally or alternatively, at step 527, the blockchain nodes 160 may receive a communication regarding a final decision or status of the chargeback request. If the payee approves (e.g., does not dispute within a threshold duration of time) the chargeback request, then the blockchain nodes 160 may update the blockchain ledgers 162 to indicate that the chargeback has been confirmed. Otherwise, if the payee rejects or disputes the chargeback request, the payer bank 168 or a third-party entity (e.g., a third party arbitrator or other independent third) may make a final decision regarding whether the chargeback request is to be approved. This decision is communicated to the blockchain nodes 160. At step 528, the blockchain nodes 160 may transmit the decision to any network participants affected by the chargeback request. The payer bank may send a double confirmation to the mobile device 154 regarding the chargeback via text or 2FA. At step 530, if the chargeback has been approved, the funds may be refunded back from the payee bank 169 to a correct account of the payer bank 168 via the banking core 167. In some embodiments, the payer bank 168 may obtain funds from the payee bank 169 via methods such as closed loop, ACH pull, FedNow®, or RTP.

In some embodiments, the payer bank 168 or the payee bank 169 may not be fully integrated with the consolidated ecosystem 150. If only the payer bank 168 is fully integrated with the consolidated ecosystem 150, the payer bank 168 pulls the refund or chargeback amount from the payee bank 169. Meanwhile, if only the payee bank 169 is fully integrated with the consolidated ecosystem 150, then the payee bank 169 may push the refund or chargeback amount back to the payer bank 168.

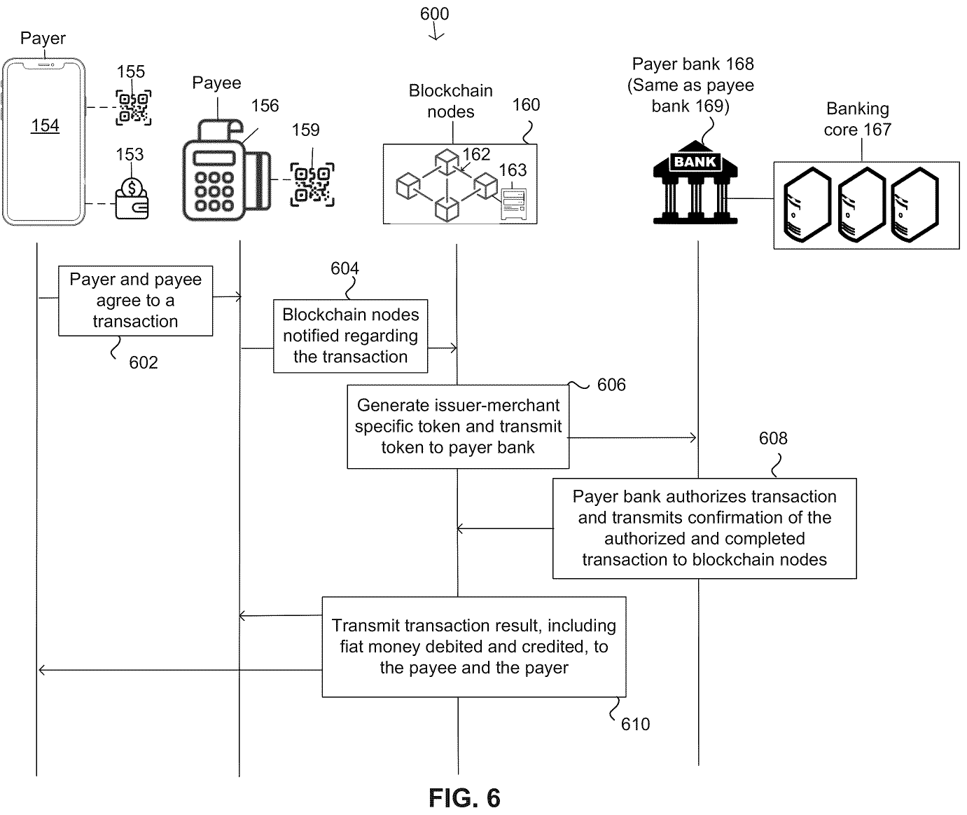

The consolidated ecosystem 150 may be sufficiently flexible and versatile to address a number of settlement scenarios. In a first settlement scenario 600, as illustrated in FIG. 6, the payer bank 168 and the a payee bank 169 may be same banks. In step 602, a payer and payee may agree to a transaction as a result of the payer scanning or inputting a code of the payee via the digital application 155, or the payee scanning or inputting a code of the payer via the digital application 159. In some embodiments, the payee may, instead of using the digital application 159, utilize the same digital application 155 as the payer. In step 604, the payee may transmit a notification to the blockchain nodes 160 regarding the transaction. In step 606, the blockchain nodes 160 may authorize the transaction, such as from the payer bank 168, for example, by checking a validity of a payment account and for a sufficient balance. After authorization, the blockchain nodes 160 may generate an issuer-merchant specific token (e.g., a payer bank-payee specific token). This issuer-merchant specific token may include a payment amount. The blockchain nodes 160 may then transmit the issuer-merchant specific token to the payer bank 168 for authorization and settlement. In step 608, the payer bank 168 may, upon authorization, debit a fiat amount from the account of the payer and credit the fiat amount to the merchant or payee, in a closed loop manner and transmit a confirmation of the authorized and completed transaction to the blockchain nodes 160. The blockchain nodes 160 may record a confirmed transaction in response to receiving this confirmation, and transmit a result of the confirmed transaction to the payer and the payee, in step 610. The first settlement scenario may be particularly applicable for medium to small sized banks or credit unions.

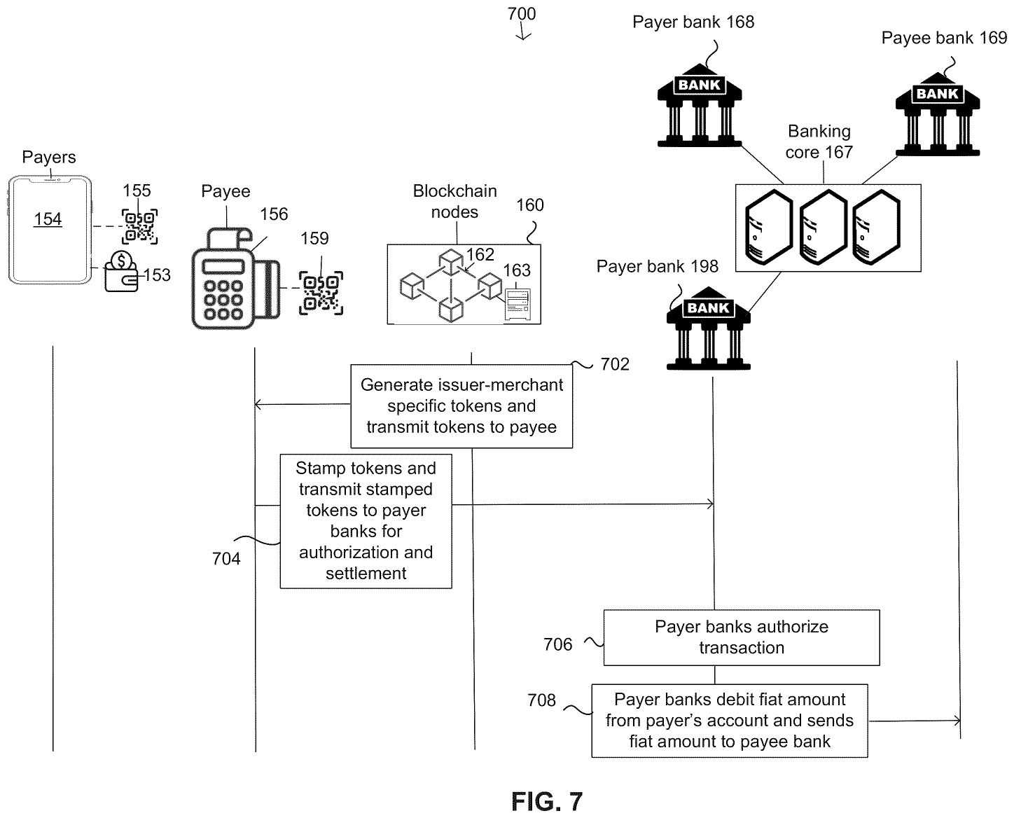

In a second settlement scenario 700, as illustrated in FIG. 7, a payer bank and the payee bank may be different banks. In step 702, after authorization of a transaction, the blockchain nodes 160 may generate issuer-merchant specific tokens which represent payment information, including payment amount, of transactions. The blockchain nodes 160 may route the issuer-merchant specific tokens to the merchant. In step 704, the merchant receives the issuer-merchant specific tokens, stamps them, and transmits the issuer-merchant specific tokens, via the blockchain nodes 160, to one or more respective banks (e.g., the payer bank 168 and/or payer bank 198 corresponding to different payers) for authorization and settlement. Each of the respective banks may authorize the transactions in step 706. In step 708, after authorization, each of the payer banks debit a fiat amount from a payer account, and send the fiat amount to a merchant bank via techniques such as RTP or FedNow, which may be real-time, or ACH or Zelle, which may be same-day.

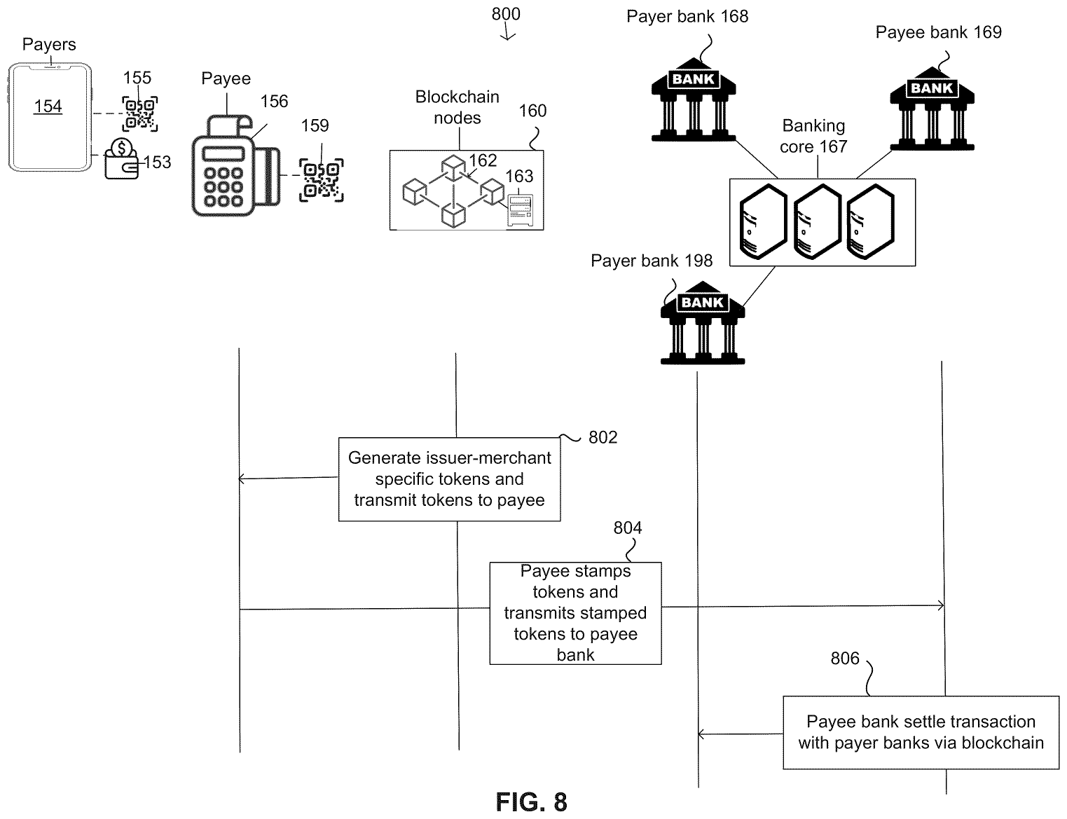

In a third settlement scenario 800, as illustrated in FIG. 8, a payer bank and a payee bank may be different banks. Unlike in the second settlement scenario 700, the merchants or payee may stamp the issuer-merchant specific tokens and send the issuer-merchant specific tokens to a payee bank instead of the payer banks. The payee bank may settle with the payer bank via the blockchain nodes 160. In FIG. 8, in step 802, after confirmation of a transaction, the blockchain nodes 160 may generate an issuer-merchant specific token and transmit the issuer-merchant specific token to the payee. In step 804, the payee may stamp the issuer-merchant specific token and transmit the issuer-merchant specific token to the payee bank 169. In step 806, the payee bank 169 may settle the transaction with the one or more payer banks 168, 198, via the blockchain nodes 160.

The consolidated ecosystem 150 may be leveraged by different types of financial institutions. As a first usage scenario targeted towards non-card financial products, such as card alternatives, the blockchain nodes 160 may be hosted by a network or consortium of regional or community banks and credit unions. When a payer and payee may initiate a transaction using mechanisms previously described, for example, in FIGS. 1B and 3, the payer and payee may exchange transaction details including an amount to be paid, an account to be debited, and/or an account of the payee (e.g., a merchant bank account). The merchant or payee may, following an initiated transaction or following settlement, update a retail management system, which may be connected via a PoS or gateway. Security features such as biometrics, passcodes, device verification, geolocation, and digital signatures may be used to authenticate either or both the payer and the payee. In some embodiments, if account information is not included from a code, the payer may specify an account from which funds are to be withdrawn. An account may include any of checking or savings accounts, loans, credit lines, equity lines, and other credit score-based credit accounts.

Either the payer or the payee, via the digital application 155 and/or the digital application 159, may transmit an indication to the blockchain nodes 160 regarding the initiated transaction. In some embodiments, the blockchain nodes 160 store smart contracts regarding actions, or a workflow process, to be triggered, upon receiving an indication regarding the initiated transaction. The workflow process may include directly routing relevant transaction details to a payer bank. The payer bank may transmit the settlement amount to a payee bank directly or via a settlement bank or process (e.g., RTP, FedNow®, ACH, Zelle®) or closed loop.

The first usage scenario provides benefits to the network participants of the consolidated ecosystem 150. This scenario enables convenient deployment of debit or credit-like payment solutions, under control of local or regional banks and credit unions, while leveraging Closed Loop, RTP, FedNow® and instant payment capabilities. This scenario may be particularly applicable for offering a debit-credit-like product or mechanism without issuing a credit or debit card. Such a product may provide advantages of lower transaction fees, faster settlement time, and higher payer rewards. At the same time, financial institutions may share processing and acquiring fees savings due to the elimination of intermediaries that were previously present in a traditional card rail. Meanwhile, payees such as merchants are provided with an easily deployed, affordable solution, with no merchant account requirements, no requirement of a payment service provider, and no gateway fees. Payees can also use the current PoS system, and transactions may be treated as a cash payment. The PoS may generate a final payment amount including any tax and tip under an option of a cash payment or an equivalent cash transaction. A final payment amount may be inputted into the application 151, and settlement may be performed by moving fiat cash from an account of the payer bank 168 to an account of the payee bank 169. Payers, such as consumers and businesses, are provided with a convenient digital application, with the ability to select from multiple funding sources which are managed under a common account management system. Payers may also benefit from additional rewards from banking providers and/or from merchants at a PoS, as a discount on goods and/or services. At least a portion of rewards may be funded from processing cost savings from cutting intermediaries. At the same time, banking system providers, such as such as Jack Henry®, FIS®, and/or Fiserv®, and/or other systems may more efficiently adapt and leverage their systems, software, and services within the consolidated ecosystem 150, while gaining a share of transaction fees.

As a second usage scenario, traditional credit and/or debit card issuers may leverage the consolidated ecosystem 150 to enable direct point-to-point settlement, thereby lowering their processing and acquiring fees without sacrificing margins or issuer fees and consumer rewards. The second usage scenario may be particularly applicable to underserved businesses, which typically have low ticket transactions. For example, microbusinesses with revenues of under $250,000 per year, but still experience moderate or high transaction volumes, which may be particularly cost sensitive, may particularly benefit from the consolidated ecosystem 150 which is scalable. In addition, such microbusinesses may benefit from faster and more secure settlement. Such traditional credit and/or debit card issuers may also more effectively leverage other non-card payment solutions as improved alternatives to current non-card payment processes such as PayPal and Venmo.

Within the consolidated ecosystem 150, along with implementations described previously in FIGS. 1B, 1C, 2-3, 4A, 4B, and 5-8, network participants are provided a multitude of benefits. Specifically, financial entities such as banks and/or credit unions may offer targeted and tailored products and/or rewards, implemented within the consolidated ecosystem 150 for streamlined and secure processing. Some of the payment funding accounts or sources, as previously alluded to, include both card and non-card-based mechanisms, such as term loans, SBA loans, traditional credit lines, equity lines, other credit lines issued based on credit scores, and/or checking or savings accounts. In some embodiments, non-card issuing entities may provide digital wallets and/or applications connected to payment funding accounts or sources such as credit or debit mechanisms issued based on credit score, term loans, SBA loans, credit lines whether collateralized or uncollateralized, or checking or savings accounts while charging fees. In some embodiments, card issuing entities may provide digital wallets and/or applications connected to credit and/or debit cards along with same or similar payment mechanisms as non-card issuing entities. Card issuing entities may have more flexibility to set issuing or processing fees within the consolidated ecosystem 150. These issuing or processing fees were previously paid to intermediary entities which only exist within a traditional card rail ecosystem and do not exist in the consolidated ecosystem 150. The consolidated ecosystem 150 may be compatible with different digital applications and/or wallets.

In some embodiments, different functionalities or mechanisms may be combined or integrated together. For example, credit and debit features may be combined into a single card or within a single digital application or wallet. As a result, a payer has flexibility to select a payment funding source or account from a digital application or a digital wallet. For example, a payer may select from a debit or a credit feature because the blockchain nodes 160 record information and updates associated with different accounts, including both a debit account and a credit account. Upon selection of a payment mechanism, the blockchain nodes 160 will debit or otherwise update records of the proper account.

For other network participants, monetary savings and rewards may trickle down due to elimination of intermediaries that otherwise collected issuing or processing fees. In addition, payers may be beneficiaries of targeted rewards provided by the financial entities. Meanwhile, the payees may have more control in issuer and processing fee arrangements compared to a traditional card ecosystem, in which the intermediaries controlled the issuer and processing fees. Additionally, providers of a banking system may also benefit from more efficiency and more secure data recording, storage, and processing within the consolidated ecosystem 150.

In some embodiments, the participants within the consolidated ecosystem 150 may receive and transmit communications via a same digital application (e.g., the digital application 155 of FIG. 1B) or different digital applications (e.g., the digital applications 155 and 159 of FIG. 1B). The participants may register and be authenticated via a third-party application (e.g., Plaid®), consistent with the principle of know your customer (KYC). For example, a payer may set up or change security information such as a pass code, or utilize a passcode corresponding to one or more banking applications. A payer may be authenticated via the security information and biometrics information. Via the digital application 155, a payer may carry and register multiple cards, multiple accounts, and/or multiple banks that link to a back-end banking system, such as Jack Henry®, FIS®, and/or Fiserv®, a digital core of a bank, management system, or an open banking application programming interface (API). In some embodiments, the digital application 155 may be synchronized with or incorporated into a banking application. In some embodiments, the multiple cards and/or accounts may be integrated together, for example, into a programmable card. The digital wallet 153 linked to the digital application 155 may be implemented as a smart wallet that automatically selects a card or an account for each particular transaction based on criteria such as interest rate, rewards, interest rate, available balances, type of transaction, geolocation, and/or industry or other merchant identification or classification information. In some embodiments, the smart wallet may automatically map a payment source to certain categories of transactions. In other embodiments, a payer may choose a payment source. In some embodiments, the digital application 155 may display any updates of transaction statuses to the payer, which may be received from the blockchain nodes 160. For example, transaction statuses may show that a transaction status is approved by a payer, payer bank, and/or payee, cancelled by a payee resulting in a reversal, settled meaning that a transaction amount has been sent, disputed which results in a potential chargeback, or refunded.

The digital card may display messages (e.g., changes in terms, promotions), transaction history, current balance, interest rate, any available credit, credit lines, and/or balance, if applicable. The transaction history may be exported or backed up to an external database system. In some embodiments, the digital wallet 153, if lost, may be restored by downloading the digital application 155 and syncing a new device with the card issuer management system using biometrics and/or 2FA. In some embodiments, the digital card and physical credit or debit cards may link to a same credit or debit account credit card management system. Both the digital card and the physical credit or debit cards may go through the non-blockchain traditional card ecosystem 100 and/or the blockchain ecosystem 150. The digital wallet 153 may be desktop, laptop, pad, and/or mobile based. In some embodiments, any relevant previous descriptions of the digital wallet 153 may also apply to the digital wallet 151 of the merchant (e.g., the payee). The digital wallet 151 of the merchant may be integrated or linked to ERP, CRM, or other accounting systems. The digital wallet 151 may receive an issuer specific token as representation of a payment, and stamp the issuer specific token with a merchant mark or stamp. The digital wallet 151 may send the tokenized payments to the card issuer or the acquirer/merchant processor.

Meanwhile, a payee may indicate an identity or type of the payee, such as whether the payee is a merchant, during registration and authentication through its digital application (e.g., the digital application 159). If the payee is a merchant, then the merchant may input identifying information such as an industry, location including address and/or zip code, tax identifier information, banking information including account and routing number. In some embodiments, the identifying information may be transmitted to the consolidated ecosystem via a third-party application (e.g., Plaid®). The merchant may also input any registration information stored in existing databases (e.g., a Dun & Bradstreet merchant industry code). A merchant may have multiple devices, accounts, and/or digital wallets supported via the digital application 159. In some embodiments, the merchant may use each wallet to receive payments from a different issuer or issuing bank, or alternatively, use a single wallet to receive payments from different issuers or issuing banks. In some embodiments, the wallet may be integrated or linked to accounting system such as ERP, CRM, or other accounting system.

Through the digital application 159, the merchant may set discount programs, such as an instant or automatic discount percentage or amount, which may be set up to have no expiration dates, or alternatively, set up with expiration dates. The digital application 159 may reflect the discounted amount so that in a settlement of payment, the payer bank only pays the settlement amount after the discount. In some embodiments, if transactions are associated with banking and/or network processing fees, the settlement amount may also exclude the banking and/or network fees. In some embodiments, the digital application 159 may display any updates of transaction statuses to the payee, which may be received from the blockchain nodes 160. For example, transaction statuses may show that a transaction status is approved by a payer, payer bank, and/or payee, cancelled by a payee resulting in a reversal, settled meaning that a transaction amount has been sent, disputed which results in a potential chargeback, or refunded.

For the payee, the digital application 159 may generate, store, or otherwise obtain one or more identification codes, such as a QR code and/or a numeric code. For example, the digital application 159 may generate a QR code for every proposed transaction. The QR code may contain merchant information including merchant payment information such as a wiring or routing number and account number, which may be encrypted, and or a payment amount. Alternatively, instead of generating a QR code, the digital application 159 may obtain a QR code separately or generate a static QR code linked to bank info. The QR code may be posted on a stand or other location. The digital application 159 may also store a unique numeric code for the payee. The numeric code may be coded according to primary industries and locations (e.g., zip code). The digital application 159 may link to a retail management system, both for online merchants and merchants having a physical site. The digital application 159 may be embedded or programmed with security and compliance features such as geolocation-based fraud detection, biometrics and passcode authentication, encryption of banking information, banking compliances regarding chargebacks and refunds, two-factor authentication or two-step verification, and standards consistent with PCI DSS.

The digital application 159 may facilitate online transactions via a built-in plugin for online checkout and incorporation with an online site of the merchant. The digital application 159 may generate a QR code or an input passcode during an online checkout process, which includes a payment amount. A payer may scan the QR code or input the passcode to complete and confirm a transaction. The digital application 159 may connect to an API of a PoS or a terminal (e.g., the terminal 156).

The consolidated ecosystem 150 may further be configured to efficiently and securely process transactions associated with gift and/or prepaid cards. Gift cards may be exchanged by any qualified individuals or entities via an account at a financial institution. A gift card buyer may download a digital application, register, and be authenticated (e.g., via phone number verification such as 2FA). A gift card seller may download the digital application and register using bank account verification. A gift card buyer may scan a QR code at a gift card seller's application or stand and purchase a gift card with a specified input amount. Alternatively, a gift card seller may scan a QR code at a gift card buyer's application and sell a gift card with a specified input amount. Here, the blockchain nodes 160 may be hosted by any combination of a card network of the gift card, a card issuer of the gift card, a bank, a credit union, a merchant, or other entities. The blockchain nodes 160 may receive an indication that a QR code corresponding to a gift card has been scanned. The blockchain nodes 160 may authorize a purchase from a gift card buyer's bank or credit union by confirming or receiving a confirmation, such as via the banking core 167, that the gift card buyer has a sufficient balance. Following authorization, the bank of the gift card buyer may settle the transaction with the bank of the gift card seller. A gift card buyer's bank or credit union may send fiat money to the gift card issuer's bank or credit union account, for example, via ACH, RTP, FedNow, closed loop, or other methods. A gift card issuer's bank or credit union fills the purchased amount to the buyer's application or wallet via the blockchain nodes 160. Alternatively, the gift card buyer may transact via the non-blockchain ecosystem 100, using a credit or debit card, or cash. Once payment is completed, a gift card seller will notify, via the blockchain nodes 160, the gift card issuer's bank or credit union, to fill the purchased amount to the buyer's digital application or digital wallet.

Following the purchase, the gift card seller may transfer a gift card amount to the gift card buyer's digital wallet and/or digital application, via the blockchain nodes 160. The blockchain nodes 160 may confirm or receive a confirmation that the gift card seller has a sufficient balance to sell the gift card to authorize the transfer, and records the transfer.

The blockchain nodes 160 may track and record any transactions made using a gift card. A transaction is initiated by the gift card holder scanning a payee QR code, or the payee scanning a QR code belonging to the gift card holder, using a digital application or a digital wallet belong to both the gift card holder and the payee. Both the gift card holder and the payee may confirm the transaction using security measures such as pin codes and biometrics. The blockchain nodes 160 may tokenize payment information and authorizes the payment by confirming, with the gift card issuer's bank, that a balance on the gift card is sufficient. Following authorization, the gift card issuer bank may debit a partial of full balance of the gift card account and send funds from the gift card issuer bank to the payee account at the payee's financial institution, via closed loop, ACH, RTP, FedNow, or other similar payment mechanisms. In some embodiments, following a partial or full usage of a gift card balance, the balance may be deducted from a digital application or a digital wallet of the payer, and recorded on the blockchain nodes 160, as well as the gift card issuing bank or credit union.

For prepaid cards, some aspects are similar to the aforementioned discussion of gift cards. Any qualified individual may open an account at a bank, credit union, or other financial institution and issue a prepaid card. A prepaid card buyer may download the digital application and register using phone and verify, for example, using phone number verification such as 2FA. Meanwhile, a prepaid card seller downloads the digital application and registers with bank verification. A prepaid card buyer may scan a QR code at the prepaid card seller's digital application or stand. Alternatively, the prepaid card seller may scan the QR code of the prepaid card buyer's application. The prepaid card buyer or seller may specify an amount. The blockchain nodes 160 may authorize a purchase from a prepaid card buyer's bank or credit union, which may include verifying sufficient balance or receiving a confirmation of a sufficient balance. The blockchain nodes 160 may be hosted by any combination of a card network of the prepaid card, a card issuer of the prepaid card, a bank, a credit union, a merchant, or other entities. The prepaid card buyer's bank or credit union transmits fiat money to the prepaid card issuer's bank or credit union account via methods such as ACH, RTP, FedNow, or closed loop. The prepaid card issuer's bank or credit union fulfills the purchased amount to the prepaid card buyer's digital application or wallet via the blockchain nodes 160. In some embodiments, government agencies can fulfill specific prepaid cards, digital applications, and/or wallets under certain programs such as welfare, refunds, or cash distributions. These fulfillments may be recorded and tracked via the blockchain nodes 160. The prepaid card buyer can also transact via the traditional card ecosystem 100, using credit or debit card, or cash. Once completed, the prepaid card seller may notify the prepaid card issuer's bank or credit union to fulfill the purchased amount to the prepaid card buyer's digital application or digital wallet via the blockchain nodes 160, and send the fiat money to the prepaid card issuer.

During spending of the prepaid card, a prepaid card holder's digital application and/or digital wallet may scan a payee's QR code and specify a payment amount, or alternatively, the payee's digital application and/or digital wallet may scan the prepaid card holder's prepaid card QR code and specify a payment amount. In some embodiments, both the merchant and/or payee, and the prepaid card holder, may confirm the transaction, for example, using a pin code, biometrics, and/or other authentication methods. The blockchain nodes 160 may tokenize the payment information, including the amount, and send the tokenized payment information to the prepaid card issuer's bank or credit union, which may confirm sufficient balance and authorize the payment. In some embodiments, after authorization, the prepaid card issuer's bank debit spending amount at a prepaid card issuer's account may send fiat money to a merchant account at a bank or credit union using mechanisms such as closed loop, ACH, RTP, or FedNow. After partial or full usage of the prepaid card balance, the balance may be deducted from a payer's digital wallet or digital application and recorded on the blockchain nodes 160, and at the issuer bank or credit union.

The consolidated ecosystem 150 may further be configured to efficiently and securely process transactions associated with credit issuing or lending. Any qualified individual or entities may open an account at a bank, credit union, or financial institution and issue credit lending to qualified individuals and businesses based on criteria such as credit scores. The credit issued may be manifested as a one-time credit, multiple-time credit, or revolving credit line. A recipient of the credit (e.g., a borrower) may use a digital application (e.g., the digital application 155 or a digital application associated with a bank) to apply for credit or link to credit accounts at the financial institution. An issuance service may provide approval data, including information and scoring for lenders for decision making.

The credit lending accounts may be linked in real-time or near real-time at a PoS device or at the terminal 156, or linked to an established credit lending account prior to a transaction. A merchant associated with the PoS device or the terminal 156 may lend a credit line to a payer. The merchant may have the first opportunity to lend the credit line to the merchant customer. Subsequently, other lenders beside the merchant may lend a credit line to the merchant customer. The option of credit lending accounts provides an additional funding source that is linked to the digital application 155 of the device 154, in addition to direct bank-linked accounts and linked credit cards.

To utilize credit when making a transaction, a borrower may scan a QR code of a payee and confirm a payment transaction with the payee. Alternatively, a payee may scan a QR code of the borrower and confirm a payment transaction with the borrower. The blockchain nodes 160 may tokenize the payment information, including a payment amount, borrower and payee bank information including respective routing and account numbers, and send the payment information to a banking system or banking core of a bank that hosts or owns the credit lending account. The hosting bank may verify a balance of the credit, debit a payment amount, and send a confirmation to the payee via the digital application 159 to complete the transaction. The hosting bank may settle the transaction, once confirmed, via closed loop, FedNow, RTP, ACH, or Zelle, or related payment mechanisms. Refunds, chargebacks, preauthorizations, and/or reversals may be handled in a similar manner from that described in FIGS. 3, 4A, 4B, and 5.

In some embodiments, a credit lending account management system, similar to a credit card management system, may manage activities of borrowers related to payback and/or default. In some embodiments, the credit lending account management system may be cloud-based. The credit lending account management may interface with a borrower via the digital application 155, to manage functions such as displaying updated status of the credit, principal and interest, and scheduled payments. In some embodiments, credit lending may be programmable based on a purpose, project, geographical attributes of a prospective borrower, and/or an industry of the prospective borrower. In some embodiments, the digital application 155 may select a best line of credit, a best credit lending account or a best payment method to use based on criteria such as interest rate and effects on credit score. In some embodiments, the digital application 155 may link to multiple credit lending accounts at same or different banks or lenders. The digital application 155 may also communicate with an issuer or a lender.

In summary, the consolidated ecosystem 150 provides an improved computing solution that enhances efficiency, cost-effectiveness, and security of processing transactions. The consolidated ecosystem 150 improves storing, recording, routing, and processing of transactional data via direct point-to-point linkage between participants, such as between a payer or payee and downstream settlement and validation systems of banks. The consolidated ecosystem 150 is configured to implement different scenarios during a transaction, such as reversals, preauthorizations, refunds, and chargebacks. The consolidated ecosystem 150 is also compatible with different payment instruments including card-based payments (e.g., gift or prepaid cards), and non-card-based payments (e.g., card alternatives, credit lines).

In some embodiments, additionally or alternatively to using the blockchain nodes 160 for routing and recording of transactions, central routing may be implemented. In central routing, transaction information may be routed via a central platform, server, or cluster of servers, to the banking core 167. This process may be accomplished without the blockchain nodes 160, but rather, may be implemented by computing nodes which are not part of a blockchain or blockchain network. Thus, in FIG. 1B, one or more computing clusters may replace the blockchain nodes 160. Settlement may be performed via closed, loop, ACH, FedNow®, and/or RTP, as previously mentioned.

In some embodiments, a computing system comprises a plurality of computing nodes. The plurality of computing nodes is coupled to and communicating with a peer-to-peer network. A computing node of the plurality of computing nodes comprises: one or more processors; a storage device, coupled to the one or more processors, and storing instructions for execution by at least some of the one or more processors; a communications subsystem, coupled to the one or more processors and configured to communicate with at least one or more other computing nodes of the plurality of computing nodes, with one or more upstream entities (e.g., the devices 152), and with one or more downstream entities (e.g., the banking core 167), wherein the one or more processors operate to configure the system to perform operations. The operations include receiving, from the one or more upstream entities, an indication of a transaction between transacting entities associated with the one or more upstream entities; recording, within a distributed ledger or storage associated with the computing node, the transaction; routing, in a point-to-point manner, the transaction to the one or more downstream entities; receiving, from the one or more downstream entities, an authorization of the transaction; routing, to the one or more upstream entities, an indication of the authorization of the transaction; and updating the record of the transaction at the distributed ledger or the storage associated with the computing node to indicate the authorization of the transaction and to provide a guarantee of validity of the transaction.

In some embodiments, the peer-to-peer network is dedicated to a particular category of an upstream entity, and the peer-to-peer network implements the distributed ledger.

In some embodiments, the plurality of computing nodes comprise a first subset of computing nodes that together form a first blockchain and a second subset of computing nodes that together form a second blockchain, wherein the first blockchain is hosted and controlled separately from the second blockchain.

In some embodiments, each of the plurality of computing nodes is operated by multiple node servers for redundancy and to guarantee availability of each of the plurality of computing nodes.

In some embodiments, the plurality of computing nodes comprise a first subset of computing nodes that together form a first blockchain and a second subset of computing nodes that together form a second blockchain, wherein the second blockchain network is a redundant and backup network to the first blockchain network.

In some embodiments, a number of the plurality of the computing nodes is adjustable.

In some embodiments, the peer-to-peer network does not store monetary value.

In some embodiments, the downstream entities comprise a banking core, the core comprising an authentication and settlement system to authenticate and settle any received transaction.

In some embodiments, the plurality of computing nodes comprise a first subset of computing nodes that together form a first blockchain and a second subset of computing nodes that together form a second blockchain, wherein the first blockchain and the second blockchain are hosted by a virtual machine on a common server.

1. A system comprising:
a plurality of computing nodes, the plurality of computing nodes coupled and communicating within a peer-to-peer network in a point-to-point manner, wherein a computing node of the plurality of computing nodes comprises:
one or more processors;
memory coupled to the one or more processors, and storing instructions for execution by at least some of the one or more processors;
a distributed routing network or a centralized routing platform associated with the computing node; and wherein the one or more processors operate to configure the computing node to perform:
receiving, via a communications subsystem, from one or more upstream entities, a record of a transaction between the one or more upstream entities or between transacting entities associated with the one or more upstream entities;
recording, within the distributed routing network or the centralized routing platform associated with the computing node, a log entry comprising the transaction;
routing, in a point-to-point manner, the log entry of the transaction to the one or more downstream entities;
receiving, from the one or more downstream entities, an authorization of the transaction;
routing, to the one or more upstream entities, the authorization of the transaction; and
updating the record of the transaction at the distributed routing network or a centralized routing platform by appending the authorization of the transaction and to provide a guarantee of validity of the transaction.

2. The system of claim 1, wherein the one or more processors operate to configure the computing node to perform:
in response to receiving the authorization, initiating a fiat settlement from a payer bank account to a merchant bank account via back end settlement channels.

3. The system of claim 1, wherein the peer-to-peer network and the plurality of computing nodes are configured to process transactions belonging to a particular category of transacting entities, the particular category being defined based on a size, a type, or a region of the transacting entities; or
wherein the peer-to-peer network is dedicated to a particular transacting entity, the peer-to-peer network and the plurality of computing nodes being configured to process transactions belonging to the particular transacting entity.

4. The system of claim 3, wherein the record of the transaction comprises an indicia that specifies a transacting category of a particular transacting entity involved in the transaction; and
the one or more processors operate to configure the computing node to perform:
verifying that the transacting category matches the particular category; and
the receiving of the record of the transaction is in response to verifying that the transacting category matches the particular category.

5. The system of claim 1, wherein the plurality of computing nodes comprise first computing nodes and the peer-to-peer network comprises a first peer-to-peer network; and the system further comprises second computing nodes coupled to and communicating within a second peer-to-peer network, the first peer-to-peer network being dedicated to a first category of transacting entities and the second peer-to-peer network being dedicated to a second category of transacting entities, the first category and the second category being distinguished based on a size, a type, or a region of the transacting entities.

6. The system of claim 1, wherein each of the computing nodes are hosted by a different party selected from parties, the parties comprising a card network, an issuer, a bank, a credit union, and a merchant.

7. The system of claim 1, wherein the plurality of computing nodes are hosted by a virtual computing machine on a physical server, the virtual computing machine comprising:
one or more simulated central processing units (CPUs) or simulated graphical processing units (GPUs) accessible by the plurality of computing nodes; and
a hypervisor that maps the simulated CPUs or simulated GPUs onto the physical server.

8. The system of claim 1, wherein the plurality of computing nodes comprise first computing nodes; the virtual computing machine comprises a first virtual computing machine; and the system further comprises second computing nodes hosted by a second virtual computing machine on the physical server.

9. The system of claim 1, wherein the computing node is configured to transmit and receive communications directly to and from the one or more upstream entities and the one or more downstream entities in a point-to-point manner, the transacting entities comprise a payer and a merchant, the one or more upstream entities being associated with a device, a digital application, or a digital wallet of the merchant or the payer, the transaction comprises a credit or a debit transaction using a transaction instrument; and the one or more downstream entities are associated with a digital banking core or an issuer or processing system of the transaction instrument.

10. A system comprising:
a plurality of computing nodes, the plurality of computing nodes coupled and communicating within a peer-to-peer network in a point-to-point manner, wherein a computing node of the plurality of computing nodes comprises:
one or more processors;
memory coupled to the one or more processors, and storing instructions for execution by at least some of the one or more processors;
a distributed routing network or a centralized routing platform associated with the computing node; and wherein the one or more processors operate to configure the computing node to perform:
receiving, via a communications subsystem, from one or more upstream entities, a record of a transaction between the upstream entities or between transacting entities associated with the one or more upstream entities, the record indicating transaction data;
generating a token specific to the upstream entities or the transacting entities, the token encoding the transaction data;
transmitting, in a point-to-point manner, the generated token to an upstream entity of the upstream entities or a transacting entity of the transacting entities;
receiving a stamped token from the upstream entity or from the transacting entity, the stamped token representing an approval of the recorded transaction;
routing, in a point-to-point manner, the stamped token to one or more downstream entities;
receiving an indication of an authorization of the transaction from the one or more downstream entities;
routing, to the upstream entities or the transacting entities, a record of the authorized transaction; and
recording an entry of the authorized transaction at the distributed routing network or a centralized routing platform.

11. The system of claim 10, wherein the transaction data comprises identification data of a credit account or a debit account and an amount of the transaction.

12. The system of claim 10, wherein the one or more upstream entities comprise devices or digital applications associated with a payer or a payee, the transacting entities comprise the payer and the payee, and the receiving of the record of the transaction is in response to a scanning on the digital application of a quick response (QR) code or in response to a communication between the devices associated with the payer and the payee of an inputted and approved transaction amount using a near field communications (NFC) protocol.

13. The system of claim 12, wherein the receiving of the record of the transaction is in response to a selection, on a digital application of the payer, of a credit or debit account and an approval of the transaction and transaction amount, wherein the credit or debit account is selected from any of a credit score based credit account, a term loan, a SBA loan, an uncollateralized credit line, a collateralized credit line, a checking or savings account, or a traditional credit account, and the approval of the transaction is performed using biometrics or a pass code entry.

14. The system of claim 13, wherein the one or more downstream entities is associated with a payer bank of the payer; the receiving of the indication of the authorization comprises receiving an adjustment from the selected credit or debit account of the transaction amount and the recording of the entry of the authorized transaction comprises recording the adjustment of the selected credit or debit account.

15. The system of claim 10, wherein the stamped token represents a computing command from the upstream entity that approves a payer bank of a payer to transmit a transaction amount to a payee bank of a payee in near real-time or by batching one or more transactions.

16. The system of claim 10, wherein the receiving of the indication of the authorization comprises a confirmation of a sufficient balance on a transaction account for settlement of the transaction and a settlement of the transaction using the transaction account.

17. The system of claim 16, wherein the settlement of the transaction comprises a closed loop settlement in which the transaction account belonging to a payer is debited and a payee account is credited, wherein the transaction account and the payee account belong to a common financial institution.

18. The system of claim 16, wherein the transaction comprises a fiat transfer; and the one or more upstream entities comprise a point-of-sale (PoS) device, and the receiving of the indication of the authorization of the transaction from the one or more downstream entities corresponds to an indication of a fiat settlement from the transaction account belonging to a payer to a payee account.

19. The system of claim 10, wherein the one or more downstream entities is associated with a payer bank; and the receiving of the indication of the authorization of the transaction corresponds to posting a charge of the transaction against an account of the payer bank, wherein the transaction includes any discounts, rewards, and fees.

20. The system of claim 10, wherein the transaction comprises a refund transaction of a previous transaction; and the receiving of the record of the transaction comprises receiving an indication of the previous transaction to be refunded; or
wherein the transaction comprises a reversal of a previously unsettled transaction; and the receiving of the indication of the authorization of the transaction corresponds to a credit to an account of a payer corresponding to a previously locked amount corresponding to the previously unsettled transaction; or
wherein the transaction comprises a chargeback of a previous transaction; and the receiving of the indication of the authorization of the transaction is from a payer bank of a payer or an external entity besides the payer bank; the receiving of the indication of the authorization corresponds to a credit to an account of a payer corresponding to a previous transaction amount of the previous transaction.

21. The system of claim 10, wherein the transaction comprises a preauthorization and a final settlement according to a smart contract; and the receiving of the indication of the authorization corresponds to a locking of an amount corresponding to the preauthorization and a settlement amount of the final settlement, wherein the smart contract is recorded within the distributed ledger or the storage system.

22. The system of claim 10, wherein the one or more processors operate to configure the computing node to perform:
receiving an indication of one or more processing fees associated with a transacting entity of the transacting entities; and
recording an entry of the processing fees at the distributed ledger or the storage system.

23. The system of claim 10, wherein the one or more processors operate to configure the computing node to perform:
receiving an indication of a rating provided to a transacting entity; and
recording an entry of the rating provided to the transacting entity, wherein the rating is displayed in response to a request or upon scanning of a QR code associated with the transacting entity or inputting of an alphanumeric code associated with the transacting entity.

24. The system of claim 10, wherein the one or more processors operate to configure the computing node to perform:
generating a record or log of transactions or accounting records; and
transmitting the generated record or log to the one or more upstream entities or the one or more downstream entities periodically or in near real-time.

25. A computing system comprising:
a server configured to store wallet data from a plurality of wallets, wherein the wallets are linked to same or different accounts of a transacting entity and the wallet data comprises account data of one or more particular accounts associated with the wallets;
one or more processors; and
a memory storing instructions that, when executed by the one or more processors, causes the one or more processors to perform:
generating one or more QR codes or scannable codes encoding the wallet data and associated with the wallets;
receiving a scan of a particular QR code or a particular scannable code or an input of a particular alphanumeric code, or scanning an external QR code or an external scannable code;
receiving an input of transaction data;
receiving a confirmation of a transaction according to the transaction data;
in response to receiving the scan, the input, and the confirmation, automatically transmitting the transaction data to a downstream entity, the downstream entity comprising a distributed routing network or a centralized routing platform;
receiving an authorization of the transaction from the downstream entity; and
in response to receiving the authorization, updating the wallet data based on the transaction data.

26. The computing system of claim 25, wherein the transaction data comprises a sales tax, a tip, a discount, reward, or fee associated with the transaction.

27. The computing system of claim 25, wherein the particular QR code or the particular scannable code encodes or encrypts any or a transaction amount, and merchant bank data, the merchant bank data comprising any of an account identifier, a routing identifier, and a payment method identifier or a payment method.

28. A computing system comprising:
a server configured to store account data from a plurality of accounts;
one or more processors; and
a memory storing instructions that, when executed by the one or more processors, causes the one or more processors to perform:
generating one or more QR codes, scannable codes, or alphanumeric codes encoding the account data, wherein each of the generated QR codes, the generated scannable codes, and the alphanumeric codes are associated with one or more of the accounts;
receiving a scan of a particular QR code or a particular scannable code or an input of a particular alphanumeric code, or scanning an external QR code or an external scannable code;
receiving an input of transaction data, the transaction data comprising a transaction amount and a transacting entity;
receiving, via biometrics, two-factor authentication, or a passcode, a confirmation of a transaction corresponding to the transaction data;
selecting a particular account based on a criteria, the criteria comprising one or more incentives associated with the accounts;
transmitting, to the transacting entity, a confirmation of the transaction and the selected particular account;
receiving, from a downstream entity, an approval of the transaction; and
generating a record of the transaction.

29. The system of claim 28, wherein the downstream entity is associated with a banking application; and the approval of the transaction corresponds to a debit of the selected particular account according to the transaction amount.

30. The system of claim 28, wherein the criteria is based on a geolocation, a type of the transaction, an industry of the transacting entity, or the account data.
